(19) United States
(12) Patent Application Publication
(10) Pub. No.: US 2013/0191250 A1
(43) Pub. Date: Jul. 25, 2013

(54) SYSTEM AND METHOD FOR AUGMENTED REALITY USING MULTI-MODAL SENSORY RECOGNITION FROM ARTIFACTS OF INTEREST

(71) Applicant: Augme Technologies, Inc., New York, NY (US)

(72) Inventors: Nathaniel T. BRADLEY, Tucson, AZ (US); Jim G. CRAWFORD, Fall City, WA (US); Joshua S. PAUGH, Tucson, AZ (US); Douglas F. BENDER, Scotts Valley, CA (US)

(73) Assignee: Augme Technologies, Inc., New York, NY (US)

(21) Appl. No.: 13/658,448

(22) Filed: Oct. 23, 2012

Related U.S. Application Data
(60) Provisional application No. 61/589,707, filed on Jan. 23, 2012.

(51) Int. Cl. G06Q 30/06

(52) U.S. Cl. CPC G06Q 30/0623
USPC 705/26.61

(57) ABSTRACT

The present invention provides a system and method that permits a user to encounter an augmented reality, such as during shopping, recreation, tourism, or the like. Using a communication device and a data capture device, the user is able to capture data to the data capture device, recognizing defined attributes within the captured data, processing the recognized attributes and returning a response to the person based upon the recognized attributes. The data captured may be single mode or multi-modal data, and may consist, for example of any sensory-type input, e.g., visual, auditory, olfactory, haptics or gustatory obtained by capturing data from an artifact of interest to the user. Artifacts may consist of any type of product, activity, service, or media, or parts thereof that may serve to identify and distinguish the artifact of interest.

### CROSS-REFERENCE TO RELATED APPLICATIONS

The present application claims priority from commonly owned and co-pending U.S. Provisional Application Ser. No. 61/589,707, filed Jan. 23, 2012, which is hereby incorporated in its entirety by reference.

The present invention is related to co-pending, commonly assigned U.S. patent application Ser. No. 13/167,080, filed Jun. 23, 2011, which is hereby incorporated in its entirety by reference.

### BACKGROUND OF THE INVENTION

The present invention relates generally to systems and method for virtual shopping. More specifically, the present invention provides a system and method that permits a person to shop, using a communication device and a data capture device, by capturing data to the data capture device, recognizing defined attributes within the captured data, processing the recognized attributes and returning a response to the person based upon the recognized attributes. The data captured may be single mode or multi-modal data, and may consist, for example of any sensory-type input, e.g., visual, auditory, olfactory, haptics or gustatory obtained by capturing data from an artifact of interest to a user. Artifacts may consist of any type of product, activity, service, or media, or parts thereof that may serve to identify and distinguish the artifact of interest.

Visual inputs may consist of image capture, pattern recognition, text recognition, bar codes, such as UPC or QR codes, hand gestures, or the like. Auditory inputs may consist of music, sound recognition, sound pattern recognition, spoken word recognition, or the like. Olfactory inputs may consist of inputs from artificial noses, such as that described by Stitzel, S. E., et al. in Artificial Noses, Ann. Rev. Biomed. Eng. Vol. 13, 1-25 (August 2011) or in U.S. Pat. No. 7,261,857, gas chromatographs or other instruments for detecting the presence of airborne elements, each of which is hereby incorporated by reference. Haptic inputs may consist of data acquired by virtue of surface roughness measurements, such as by atomic force microscopy, by a tactile-sensing system such as that described by Decherchi, S., et al., IEEE Transactions on Robotics, 27(3), 635-639, June, 2011, or by tactile sensors as described in U.S. Pat. No. 7,823,467, each of which is expressly incorporated by reference. Finally, gustatory, or the taste inputs, may be obtained by employing a taste sensor, such as that described in U.S. Pat. No. 7,858,036 or the taste sensor data system described in U.S. Patent Application Publication No. 20040107053, each of which is expressly incorporated by reference.

The captured artifact data may then be used to either query the user with response options, e.g., purchase, add to shopping cart, add to favorites, etc., or may be further processed and compared with data in a data repository that recognizes the data input and returns a response to the user. The returned response may consist of further data associated with or related to the input data. Examples of the returned response may be an advertising campaign, ties to social networking communities, business-to-business information, suggestions of other products of interest to the user based upon the user's selection of the input data, suggestions of points of purchase which may be combined with pricing information, or the like.

Currently, remote or virtual shopping is accomplished using a computing device, such as a mobile phone, smartphone, tablet computer, laptop computer, desktop computer or the like. A computing device user may either browse the Internet for items of interest to purchase, such as merchandise, services, music, videos, or the like, or may interface with advertising that display barcodes that, when captured by an image capture device connected to or integral to the computing device, immediately direct the user to a site on the Internet, typically a Uniform Resource Locator (URL) address where the user may obtain further information, offers, or the like pertaining to the subject matter of the advertising.

Barcodes take the form of linear barcodes, such as Uniform Product Codes (UPC), matrix barcodes (also known as 2D codes) which encode a greater quantum of data in the barcode than linear barcodes, or three-dimensional or 3D barcodes which may be like either a linear barcode or a 2D code, but are typically embossed or engraved into a product surface and have regions of differing heights to provide still another source of data, based upon height differentials of the different encoding regions of the 3D barcode. Irrespective of the type of barcode employed on advertising or a product, the current systems and methods typically solely rely upon the single mode of optical image capture from the barcode to direct the computing device user to a specific pre-defined URL or set of pre-defined URLs on the Internet.

### SUMMARY OF THE INVENTION

It is an objective of the present invention, therefore, to provide a more robust and flexible system and method based upon multi-modal sensory data inputs. The multi-modal sensory data inputs may include, but are not limited to, optical image capture from barcodes. Other sensory data inputs may be those obtained from optical image capture from visual pattern recognition, environmental or contextual recognition, text recognition, color recognition, or motion detection, capture and recognition, e.g., hand or body gestures. Auditory sensory data inputs may also be employed with the system and method of the present invention. Examples of auditory sensory data may include, for example, music, sound patterns, natural or artificially-generated sounds, or the like. Olfactory sensory data may include, for example, data representing scents from foods, perfumes or colognes, environmental pollutants, ambient atmospheric scents, gases emitted in agricultural or industrial production, or the like. Tactile sensory data may include, for example, data representing textiles, material surface characterization, such as that during planarizing or patterning processes, e.g., sanding, finishing, spinning, polishing, etching, etc. or in artwork, or the like. Finally, gustatory sensory data may include, for example, data pertaining to relative sweetness, tartness, bitterness, spiciness, acidity, basicity or other qualities pertaining to the taste of food-stuffs.

In accordance with one aspect of the present invention there is provided a method of allowing a user to shop using portable devices using image recognition in a multi-modal mobile response engagement/promotion system or image capture technology in a multi-modal mobile response system tied to a data repository that recognizes the multi-modal data inputs. The user is allowed to shop using a mobile computing device, such as a smartphone or tablet computer, use the image recognition or image capture capabilities of the mobile computing device to recognize multi-modal data input and eliminate the need for the presence of barcode, e.g., QR, DM or any type of tag code technology, associated with advertising or product offerings. The system and method are, therefore, independent of barcode technology and GPS-based locational systems and methods. Rather, because the multi-modal data inputs may be, for example, voice, music, brand images, brand texts, product images, textile patterns, hand or body gestures, environmental patterns, such as building, signage or intersection landmarks, responses returned to the user may similarly be multi-modal and multi-variant.

In accordance with another aspect of the present invention, there is provided a system and method for enabling a user who is browsing a retailer's media, such as a print catalog, on-line web site, on-line advertisement, print advertisement, video, etc., to select an item of potential purchasing interest reflected in the retailer's media by pointing their computing device to the media, the computing device recognizes at least one data artifact in the media, i.e., product image, product brand, trademark, audio signal, etc., communicates with a remote data repository and prompts the user to select among a number of options that may include the option of adding the product to a shopping cart, the option of marking the product as a favorite, the option of obtaining more detailed information about the product, the option of searching and viewing similar product items, the option of finding competitive pricing or alternative points of purchase for the product, or the like.

In accordance with still another aspect of the present invention, a user with a supported computing device listens to music, such as a song or an instrumental piece, and decides he wants to purchase the music either for download or on a recorded medium. The supported computing device recognizes the song, either through acoustic recognition, data recognition from header information encoded with the music, such as ID3 tags, or from image capture of print media associated with recorded media for the music. The device then prompts the user to disposition an action on the song, e.g., purchase, move to shopping cart, add to a playlist or suggest other music in the musical genre or by the same artist of the music of interest. While conceptually similar to the GENIUS portion of ITUNES, where music of possible interest to a user is suggested to the user within the ITUNES application, the present invention is asynchronous with any particular media service application and permits the user to encounter media of interest across many different points of encounter, e.g., shopping mall, restaurant, home theater system, nightclub, etc., and register interest by capturing the media of interest and acting on it as described in the present invention.

In accordance with yet another aspect of the present invention, there is provided a system and method for a user, in combination with a supported computing device, to target an advertisement withtheir computing device, which causes the computing device to recognize the advertiser's brand, such as by the trademark, logo or product configuration. Data identifying the advertiser's brand is then communicated to a data repository and the user is prompted, among a number of response types, to download information from the data repository to the user's computing device, such as what other products this advertiser may have that she (the user) may be interested in, upload information about the particular product advertised, upload information about alternative products or services from competitive sources other than the advertiser, or present the user with the advertiser's full internet affiliate site, e.g., the full site, mobile site, sub-site related specifically to the item reflected in the targeted advertisement, or the like. The user may also be prompted to initiate and/or complete a purchase process.

In accordance with still another aspect of the present invention, there is provided a system and method for exchange of coupon offers between socially networked groups based upon the one group or user within a group encountering a coupon offer and exchanging the coupon offer with other members of the socially networked group. In this aspect of the invention, one user with a supported computing device is physically present at a business establishment, e.g., STARBUCKS, at a first geographical location. Another member of the socially networked group, e.g., a friend, is present at a similar business establishment, e.g., another STARBUCKS, at a remote geographical location. Both members of the socially networked group have already “checked in” via their social network. The first user targets an offer existing in the first business establishment with their computing device, e.g., a “special offer” on a STARBUCK′S coffee cup or a “special offer” posted in the store, and communicates the “special offer” via the social network to the second user. The second user is then able to target the “special offer” in the second business establishment location, and initiate a purchase process activity within the respective business establishment and location of the second user.

These and other aspects, objectives, features and advantages of the present invention will be described hereinafter with reference to general embodiments of the invention. Generally, the system of the present invention employs a Code Triggered Information Server (“CTIS”) and a CTIS Database.

Content providers, such as providers of services, print content, display content, electronic content, video content, musical content, retailers, wholesalers, web site providers, mercantile product providers, industrial product providers, or virtually any other type of commercial, informational, educational or service provider, will participate in providing content (generally and broadly referred to herein by the term “Ad”) for ultimate dissemination to users. The CTIS stores the Ads from the content providers and delivers the Ads to users based upon users registering interest in a particular artifact of interest to the user. The Ads may be stored on the CTIS server itself, storage directly coupled to the CTIS server and/or on third party servers referenced by the CTIS server.

Users may register for access to the CTIS via the internet, telephone, postal mail, and/or the like. If a particular embodiment of the CTIS requires client software for the user to install, this could be supplied upon successful user registration. In an alternative embodiment, a basic user identification packet (e.g., a “cookie”) is sent with a user's first code scan, thus establishing a basic user profile that can be filled in with greater detail at a later time.

The functionality of the CTIS and its operation and cooperation with the CTIS Database will be described in greater detail hereinafter. However, generally, the CTIS Database, which may be centralized or distributed, may be proprietary or may be an open database capable of operating across multiple database sites on the Internet, in the Cloud or across various search engines, to either look up data residing with the CTIS Database or retrieve the data from external sources and incorporate the data into the CTIS Database. The CTIS Server, therefore, acts as a type of gateway between artifacts captured by the user and Ads in the CTIS Database to be distributed to the user based upon the user captured artifacts.

As used herein the terms “Ad” or synonymously “advertising” are intended to broadly include any type of information contained within a Reply Message (described hereinafter) that either prompts a user to take an action, or for a disposition on information provided, and/or provides information to a user relevant to the artifact or alternatives to the artifact.

As used herein the term “artifact” is intended to include, without limitation, products, activities, services, print, visual, electronic or audible media, barcodes, brand names, product configurations, including, for example, packaging or container configurations, shapes or color combinations for products (e.g., pharmaceutical capsule color coding or pill shapes), video, body movements or gestures, olfactory scents, haptic or tactile stimuli, sound stimuli, and gustatory or taste stimuli.

### BRIEF DESCRIPTION OF THE DRAWINGS

The accompanying appendices and/or drawings illustrate various non limiting, exemplary, inventive aspects in accordance with the present disclosure:

FIGS. 1 a-b show combined logic and data flow block diagram illustrating a general overview of embodiments of the Graphical Code-Serving Interface (GCSI)/CTIS;

FIG. 2a shows three types of 2D barcodes that may be employed within the GCSI/CTIS; FIGS. 2b-d show logic flow for code enhancement in some embodiments of GCSI/CTIS operation;

FIG. 3 shows an illustration of one embodiment of the Scan Message data structure;

FIG. 4 shows an illustration of one embodiment of the information Base (Ad) data structure;

FIG. 5a shows an embodiment for selecting information to serve to users; FIG. 5b shows an illustration of one embodiment of a user profile data structure and an implementation of a user profile user interface in one embodiment of GCSI/CTIS operation;

FIG. 6 shows a combined logic and data flow block diagram for an embodiment of the GCSI/CTIS wherein the selection of contextual Ads is influenced by ambient conditions;

FIG. 7 shows a combined logic and data flow block diagram for a particular exemplary embodiment of the GCSI/CTIS in which an Ad for a luxury convertible is served based on warm weather conditions, a scanned code, and the user profile;

FIG. 8 shows a combined logic and data flow block diagram for a particular exemplary embodiment of the GCSI/CTIS in which an Ad for Florida travel is served based on cold/rainy weather conditions, a scanned code, and the user profile;

FIG. 9 shows a combined logic and data flow block diagram for a particular exemplary embodiment of the GCSI/CTIS in which an Ad for an ice cream shop is served based on warm weather conditions, a scanned code, and the user profile;

FIG. 10 shows a combined logic and data flow block diagram for a particular exemplary embodiment of the GCSI/CTIS in which an Ad for ponchos and umbrellas is served based on rainy weather conditions, a scanned code, and the user profile;

FIG. 11 shows a combined logic and data flow block diagram for a particular exemplary embodiment of a system in which information is returned to a user based upon image recognition of a brand name;

FIG. 12 shows a combined logic and data flow block diagram for a particular exemplary embodiment of a system in which information is returned to a user based upon image recognition of a product configuration;

FIG. 13 shows a combined logic and data flow block diagram for a particular exemplary embodiment of a system in which information is returned to a user based upon auditory recognition of music;

FIG. 14 shows a combined logic and data flow block diagram for a particular exemplary embodiment of a system in which information is returned to a user based upon olfactory recognition of a perfume scent;

FIG. 15 shows a combined logic and data flow block diagram for a particular exemplary embodiment of a system in which information is returned to a user based upon haptic recognition of a three dimensional texture;

FIG. 16 shows a combined logic and data flow block diagram for a particular exemplary embodiment of a system in which information is returned to a user based upon gustatory recognition of a flood product;

FIG. 17 shows a combined logic and data flow block diagram for an embodiment of the GCSI/CTIS wherein Ads are served to a User Agent device;

FIG. 18 shows a combined logic and data flow block diagram for a particular exemplary embodiment of the GCSI/CTIS in which an Ad for a sports team's season tickets is served along with a pay-per-view event supplied directly to a user's cable box;

FIG. 19 shows a combined logic and data flow block diagram for a particular exemplary embodiment of the GCSI/CTIS in which an Ad for virus scan subscription software is served;

FIG. 20 shows an implementation of a user interface manifesting GCSI/CTIS functionality on a portable electronic device in one embodiment of GCSI/CTIS operation;

FIG. 21 shows an implementation of a user interface manifesting GCSI/CTIS functionality on digital paper in one embodiment of GCSI/CTIS operation;

FIG. 22 shows an implementation of a user interface manifesting GCSI/CTIS functionality on a digital billboard in one embodiment of GCSI/CTIS operation;

FIG. 23 shows an implementation of a user interface manifesting GCSI/CTIS functionality for serving a short messaging service text message prompt in one embodiment of GCSI/CTIS operation;

FIG. 24 shows an implementation of a user interface manifesting GCSI/CTIS functionality on a mobile phone in one embodiment of GCSI/CTIS operation;

FIG. 25 shows an implementation of a user interface manifesting GCSI/CTIS functionality on a portable communication device in one embodiment of GCSI/CTIS operation;

FIG. 26 shows an implementation of logic flow for media acquisition in one embodiment of GCSI/CTIS operation;

FIG. 27 shows an illustration of media sampling and full media acquisition in one embodiment of GCSI/CTIS operation;

FIGS. 28 a-b show an implementation of logic flow for code scan monetization in one embodiment of GCSI/CTIS operation;

FIGS. 29 a-e show aspects of implementations of JagTag encoding and codes in some embodiments of GCSI/CTIS operation; and

FIG. 30 shows a computer systemization of the CSI/CTIS.

### DETAILED DESCRIPTION OF THE INVENTION

### Server, Computer, Client, Network, Router

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

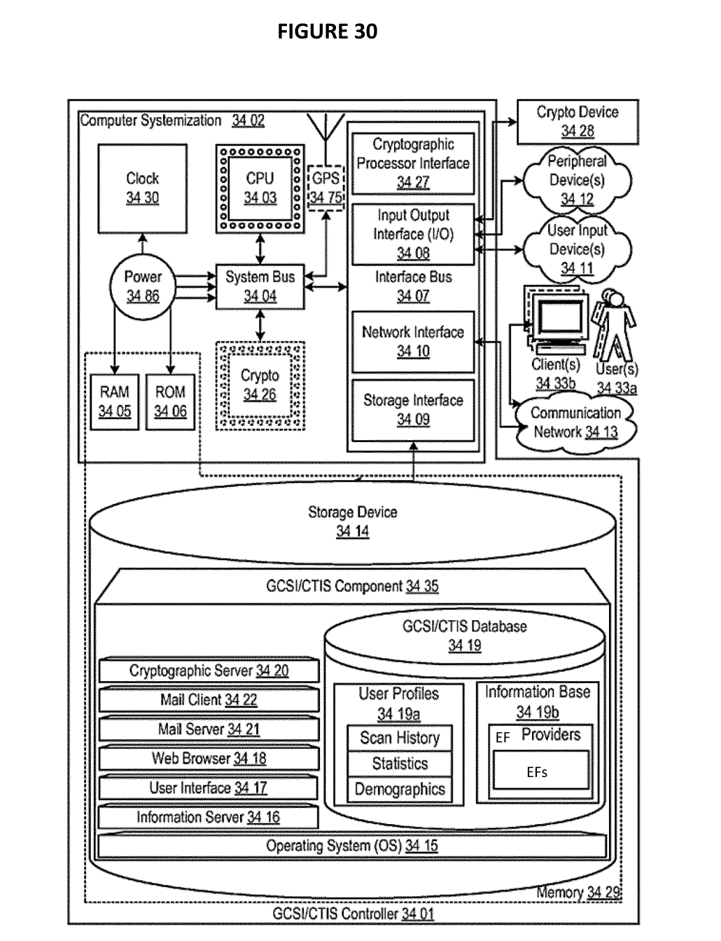

The following description, taken with reference to FIG. 30, is of an exemplary system in accordance with the present invention suitable for use in executing the method of the present invention.

### Computer Systemization

A computer systemization 3402 may comprise a clock 3430, central processing unit (CPU) 3403, a read only memory (ROM) 3406, a random access memory (RAM) 3405, and/or an interface bus 3407, and most frequently, although not necessarily, are all interconnected and/or communicating through a system bus 3404. Optionally, the computer systemization may be connected to an internal power source 3486. Optionally, a cryptographic processor 3426 may be connected to the system bus 3404. The system clock 3430 typically has a crystal oscillator and provides a base signal. The clock 3430 is typically coupled to the system bus 3404 and various clock multipliers that will increase or decrease the base operating frequency for other components interconnected in the computer systemization. The clock 3430 and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU 3403, and/or organized in numerous variations employed as exemplified by various computer systems.

The CPU 3403 comprises at least one high-speed data processor adequate to execute program components for executing user and/or system-generated requests. The CPU 3403 may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU 3403 interacts with memory through signal passing through conductive conduits to execute stored signal program code according to conventional data processing techniques. Such signal passing facilitates communication within the code triggered information server controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) or other mobile devices such as tablet computers, mobile phones, smartphones or the like may be employed.

### Power Source

The power source 3486 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 3486 is connected to at least one of the interconnected subsequent components of the code triggered information server thereby providing an electric current to all subsequent components. In one example, the power source 3486 is connected to the system bus component 3404. In an alternative embodiment, an outside power source 3486 is provided through a connection across the I/O 3408 interface. For example, a USB and/or IEEE 1394 connection carries both data and power across the connection and is therefore a suitable source of power.

### Interface Adapters

Interface bus(ses) 3407 may accept, connect, and/or communicate to a number of interface adapters, conventionally although not necessarily in the form of adapter cards, such as but not limited to: input output interfaces (I/O) 3408, storage interfaces 3409, network interfaces 3410, and/or the like. Optionally, cryptographic processor interfaces 3427 similarly may be connected to the interface bus 3407. The interface bus 3407 provides for the communications of interface adapters with one another as well as with other components of the computer systemization. Interface adapters are adapted for a compatible interface bus. Interface adapters conventionally connect to the interface bus 3407 via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 3409 may accept, communicate, and/or connect to a number of storage devices such as, but not limited to: storage devices 3414, removable disc devices, and/or the like. Storage interfaces 3409 may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 3410 may accept, communicate, and/or connect to a communications network 3413. Through a communications network 3413, the code triggered information server controller is accessible through remote clients 3433b (e.g., computers with web browsers) by users 3433a. Network interfaces 3410 may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface 3410 may be regarded as a specialized form of an input output interface. Further, multiple network interfaces 3410 may be used to engage with various communications network types 3413. For example, multiple network interfaces 3410 may be employed to allow for the communication over broadcast, multicast, and/or unicast networks.

Input Output interfaces (I/O) 3408 may accept, communicate, and/or connect to user input devices 3411, peripheral devices 3412, cryptographic processor devices 3428, and/or the like. I/O 3408 may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 3411 may be card readers, dongles, finger print readers, gloves, graphics tablets, joysticks, keyboards, mouse (mice), remote controls, retina readers, trackballs, trackpads, and/or the like.

Peripheral devices 3412 may be connected and/or communicate to I/O 3408 and/or other like facilities such as network interfaces 3410, storage interfaces 3409, and/or the like.

Peripheral devices 3412 may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices 3411 and peripheral devices 3412 may be employed, the code triggered information server controller may be embodied as an embedded, dedicated, and/or monitor-less (i.e., headless) device, wherein access would be provided over a network interface connection.

Cryptographic units such as, but not limited to, microcontrollers, processors 3426, interfaces 3427, and/or devices 3428 may be attached, and/or communicate with the code triggered information server controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

### Memory

Generally, any mechanization and/or embodiment allowing a processor to affect the storage and/or retrieval of information is regarded as memory 3429. However, memory is a fungible technology and resource, thus, any number of memory embodiments may be employed in lieu of or in concert with one another. It is to be understood that the code triggered information server controller and/or a computer systemization may employ various forms of memory 3429. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 3429 will include ROM 3406, RAM 3405, and a storage device 3414. A storage device 3414 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

### Component Collection

The memory 3429 may contain a collection of program and/or database components and/or data such as, but not limited to: operating system component(s) 3415 (operating system); information server component(s) 3416 (information server); user interface component(s) 3417 (user interface); Web browser component(s) 3418 (Web browser); database(s) 3419; mail server component(s) 3421; mail client component(s) 3422; cryptographic server component(s) 3420 (cryptographic server); the code triggered information server component(s) 3435; and/or the like (i.e., collectively a component collection). These components may be stored and accessed from the storage devices and/or from storage devices accessible through an interface bus. Although non-conventional program components such as those in the component collection, typically, are stored in a local storage device 3414, they may also be loaded and/or stored in memory such as: peripheral devices, RAM, remote storage facilities through a communications network, ROM, various forms of memory, and/or the like.

### Operating System

The operating system component 3415 is an executable program component facilitating the operation of the code triggered information server controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NTNista/XP/7 (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the code triggered information server controller to communicate with other entities through a communications network 3413. Various communication protocols may be used by the code triggered information server system controller as a subcarrier transport mechanism for interaction, such as, but not limited to: multicast, TCP/IP, UDP, unicast, and/or the like.

The operating system component 3415 may also be a mobile operating system, mobile OS, such as iOS (Apple), ANDROID, WINDOWS PHONE (Microsoft), WINDOWS PHONE 7 (Microsoft), BLACKBERRY OS (RIM), WebOS (Hewlett-Packard), MEEGO or SYMBIAN, for example. The mobile OS may be a manufacture-built proprietary operating system, a third party proprietary, or an open source operating system. Mobile OS' are employed on a wide variety of mobile devices useful with the present invention, such as smartphones and tablet computers.

### Information Server

An information server component 3416 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the code triggered information server controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the code triggered information server database 3419, operating systems, other program components, user interfaces, Web browsers, and/or the like.

Access to the code triggered information server database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the code triggered information server. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the code triggered information server as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua or Lion, Microsoft's Windows XP, Windows 7 or Unix's X-Windows provide a baseline and means of accessing and displaying information graphically to users. Mobile OS's, discussed above, also typically employ GUIs, but may also be text-based, and provide user interfaces to mobile devices.

A user interface component 3417, whether on a desktop or laptop computing device or a mobile device, is a stored program component that is executed by a CPU. The user interface may be a conventional graphic user interface as provided by, with, and/or atop operating systems and/or operating environments such as those operating systems discussed above, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 3418 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the code triggered information server enabled nodes. The combined application may be nugatory on systems employing standard Web browsers.

### Mail Server

A mail server component 3421 is a stored program component that is executed by a CPU 3403. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the code triggered information server.

Access to the code triggered information server mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 3422 is a stored program component that is executed by a CPU 3403. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 3420 is a stored program component that is executed by a CPU 3403, cryptographic processor 3426, cryptographic processor interface 3427, cryptographic processor device 3428, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the code triggered information server may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the code triggered information server component to engage in secure transactions if so desired. The cryptographic component facilitates the secure accessing of resources on the code triggered information server and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Code Triggered Information Server Database (“CTIS Database”)

The CTIS database component 3419 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CTIS database 3419 may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the code triggered information server database is implemented as a data-structure, the use of the code triggered information server database 3419 may be integrated into another component such as the code triggered information server component 3435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

Alternatively, the CTIS database 3419 may be decentralized and distributed across multiple server sites or reside entirely within a Cloud Computing Environment (the “Cloud”). Further, the CTIS database 3419 may consist of multiple databases distributed across the Internet or in the Cloud, and may, for example, include various search commercial engines such as GOOGLE, YAHOO SEARCH, BING or the like as data look up resources and pointers to URLs of putative interest to a user.

In one embodiment, the database component 3419 includes several tables 3419a,b. A user profile table 3419a includes fields such as, but not limited to: a user ID, name, email address, address, demographic profile, hardware ID, scan history record, scan statistics, and/or the like. The user profile table may support and/or track multiple entity accounts on a code triggered information server. An Information Base table 3419b includes fields such as, but not limited to: Ad provider ID, Ad ID, Ad content, Ad labels, geographic tags, temporal tags, subject tags, Ad ratings, Ad statistics, and/or the like.

In one embodiment, the code triggered information server database may interact with other database systems. For example, employing a distributed database system, queries and data access by OLBS modules may treat the combination of the code triggered information server database, an integrated data security layer database as a single database entity.

In one embodiment, user programs may contain various user interface primitives, which may serve to update the code triggered information server. Also, various accounts may require custom database tables depending upon the environments and the types of clients the code triggered information server may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 3419a,b. The code triggered information server may be configured to keep track of various settings, inputs, and parameters via database controllers.

The code triggered information server database may communicate to and/or with other components in a component collection, including itself, and/or facilities of the like. Most frequently, the code triggered information server database communicates with the code triggered information server component, other program components, and/or the like. The database may contain, retain, and provide information regarding other nodes and data.

### The Code Triggered Information Server

The code triggered information server component 3435 is a stored program component that is executed by a CPU. The code triggered information server affects accessing, obtaining and the provision of information, services, transactions, and/or the like across various communications networks.

The code triggered information server component enables the identification, generation, and aggregation of Scan Messages and Reply Messages.

The code triggered information server component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the code triggered information server employs a cryptographic server to encrypt and decrypt communications. The code triggered information server component may communicate to and/or with other components in a component collection, including itself, and/or facilities of the like. Most frequently, the code triggered information server component communicates with the code triggered information server database, operating systems, other program components, and/or the like. The code triggered information server may contain, communicate, generate, obtain, and/or provide program component, system, user, and/or data communications, requests, and/or responses.

### Distributed Code Triggered Information Server

The structure and/or operation of any of the code triggered information server node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the code triggered information server controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

In accordance with a general embodiment of the present invention, there is provided a system and method for capturing sensory-type data which is at least one of visual, auditory, olfactory, tactile or gustatory in origin, processing the captured sensory-type data to identify one or more possible matches from a comparing the captured data to data in a data repository, the one or more matches being either a product or service, returning a response to the user based upon the one or more matches and prompting the user for further action on the presented response. Eligible responses may include, for example, i) an option to purchase an item; ii) an option to add an item to a favorites list; iii) an option to add an item to a shopping cart; iv) an option display other items similar to the captured sensory-type data; v) an option to display alternative options relative to the captured sensory-type data; and/or vi) an option to display or select alternative sources for point of purchase of the item corresponding to the captured data or ii)-v) above.

One particular implementation of the system and method of the present invention is described with reference to the system and method discussed hereinafter.

### Artifact Data Capture

In one embodiment of the present invention, a code triggered information server (CTIS) employs two basic actors: (i) a user 100a who registers interest in an artifact, e.g., an activity, product or service by capturing sensory data characteristic of the artifact based upon one or more sensory characteristics of the artifact, e.g., visual, auditory, tactile, olfactory or gustatory using a data capture device 100b, e.g., a mobile computing device such as a table computer, laptop computer, smartphone, digital camera, or the like, the data capture device either, alone or in combination with another device, being capable of transmitting and receiving data, and displaying information to the user; and (ii) a server (101) capable of communicating with the user, storing/updating user profiles, communicating with databases or other data repositories, processing data received from the user and selecting information from the databases or other data repositories based upon the data received from the user to serve to the user, and communicating with the user, such as through the user's data capture device 100b, the selected information, and then accepting and acting on a user input disposition based upon the selected information, e.g., to initiate and complete a purchase process.

The data captured may be single mode or multi-modal data, and may consist, for example of any sensory-type input, e.g., visual, auditory, olfactory, haptics or gustatory. Visual inputs may consist of image capture, pattern recognition, text recognition, bar codes, such as UPC or QR codes, hand gestures, or the like. Auditory inputs may consist of music, sound recognition, sound pattern recognition, spoken word recognition, or the like. Olfactory inputs may consist of inputs from artificial noses, such as that described by Stitzel, S. E., et al. in Artificial Noses, Ann. Rev. Biomed. Eng. Vol. 13, 1-25 (August 2011) or in U.S. Pat. No. 7,261,857, gas chromatographs or other instruments for detecting the presence of airborne elements, each of which is hereby incorporated by reference. Tactile inputs may consist of data acquired by virtue of surface roughness measurements, such as by atomic force microscopy, by a tactile-sensing system such as that described by Decherchi, S., et al., IEEE Transactions on Robotics, 27(3), 635-639, June, 2011, or by tactile sensors as described in U.S. Pat. No. 7,823,467, each of which is expressly incorporated by reference. Finally, gustatory, or the taste inputs, may be obtained by employing a taste sensor, such as that described in U.S. Pat. No. 7,858,036 or the taste sensor data system described in U.S. Patent Application Publication No. 20040107053, each of which is expressly incorporated by reference.

Thus, the data capture device 100b may be any device suitable for capturing sensory data from an artifact in which the user has interest and communicating captured sensory data to a computing device or server.

As discussed above, artifacts capable of being captured include, among other things, 3D barcodes that have regions of differing heights, with the regions, their patterns and their relative heights being representative of data. In accordance with one embodiment of the present invention, the three dimensional nature of artifacts, including barcodes, may be used advantageously for allowing sight or hearing impaired individuals to capture data from artifacts with 3D codes, whether 3D barcodes per se, or other 3D surfaces capable of acting as data sources, and have that data captured, processed and provided to such individuals in a form that makes the information encoded by the 3D data more available to the user. In one particular embodiment, sight impaired individuals often employ their haptic senses to, for example, read using braille, to scan products to identify container shapes or features or the like. These skills are, of course, learned and require considerable effort on the part of the individual. The present invention may be used with sight impaired individuals to capture sensory data otherwise unavailable or difficult to access to such individuals and convert the sensory data into a usable form, e.g., sounds. Similarly, in accordance with another embodiment of the invention, a hearing impaired individual may use the present invention to capture audible sensory data, e.g., music, street sounds, warning sounds or the like, and covert such unavailable or difficult to access sensory data in a form, e.g., visual, that renders such audible sensory data more available and meaningful to a hearing impaired individual. In this manner, the present invention may be employed to simply capture and convert data existent in one sensory form to another sensory form that is more useful or available to a user having a particular disability or impairment.

### Registering User Interest (Scanning)

In one embodiment, users register interest by scanning an artifact and engaging in communication with the CTIS, which acts as a portal for users to access information supplemental to the context in which the artifact of interest is found. Users may scan artifacts found in media publications, on billboards or signs, on consumer products or packages, on websites or television screens, products themselves, brand names or trademarks, service descriptions, music, and/or the like. In doing so, the users may identify themselves via an identification code specific to the mobile device, such as the Electronic Serial Number of the mobile device, and service account with which the data capture is made. At the same time the data capture is recorded, other user information, such as time of day, user location, selection history, may be recorded and form the basis of consumer profiles that may be saved by the CTIS. As these data capture scans are indicative of interest in various subjects, goods, and/or services, they may serve as a basis for an individual customer tracking system. As such, advertisers can finely tune and efficiently tailor their efforts towards achieving maximum return on the advertising expenditure.

### Messaging

In addition to the two basic actors, the CTIS enables the creation of two types of transactional articles: i) Scan Messages (115) and ii) Reply Messages (140). The CTIS provides context-specific Reply Messages in response to Scan Messages, which are prepared in response to the registration of activity interest by the user, as represented by the user engaging in a data capture of an artifact of interest to the user, in order to supply information and/or advertising to the user based upon the data captured about the artifact. The CTIS generates Reply Messages by processing Scan Message content, accessing an information content specific to the data in the Scan Message describing the artifact, and presents information content to the user. The information content may be presented to the user after engaging with the user via a series of prompts and user directions, based upon user profile information, such as basic profiling data or history of Scan Messages by a given user or based upon pre-selected user specified criteria. As such, Reply Messages are transactional articles that heighten a user's interaction with the artifact and serve to provide the user with further information about the artifact or other products that the user may be interested in as alternatives to the artifact of interest. Without loss of generality, we will heretofore refer to the information content and/or advertising content of Reply Messages as “Ads.” The CTIS may also elect to send context and user-specific Reply Messages based solely on the user profile, without the user having recently registered activity interest, if it is determined from the user's profile, particularly the history of Scan Messages, that a particular Ad is appropriate.

### Overview of the CTIS

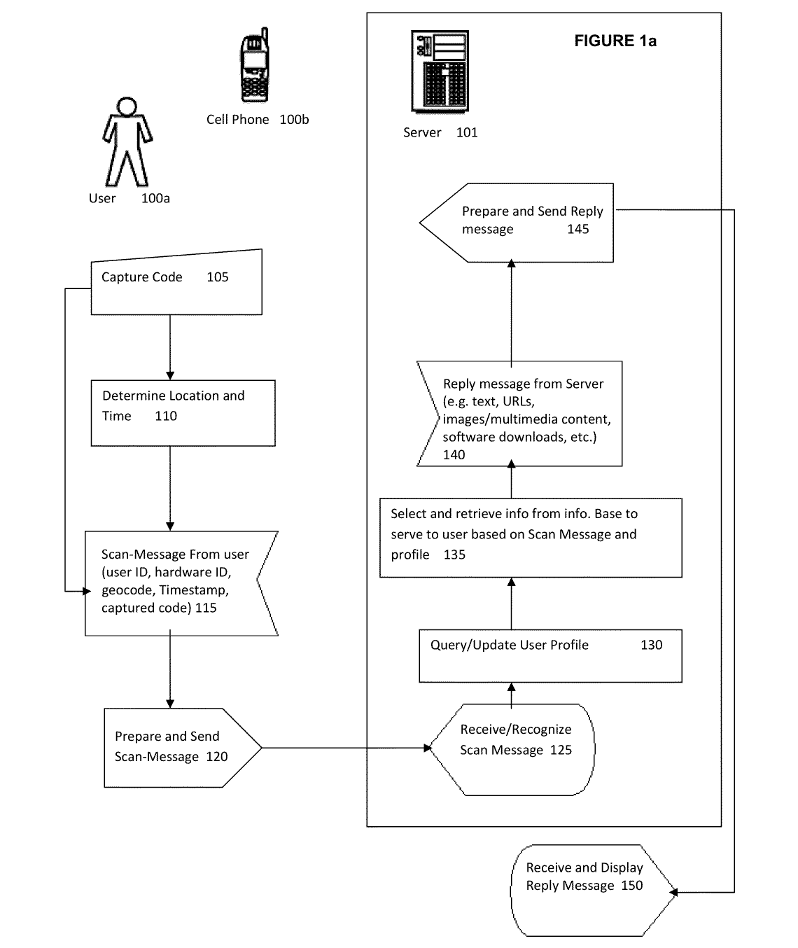

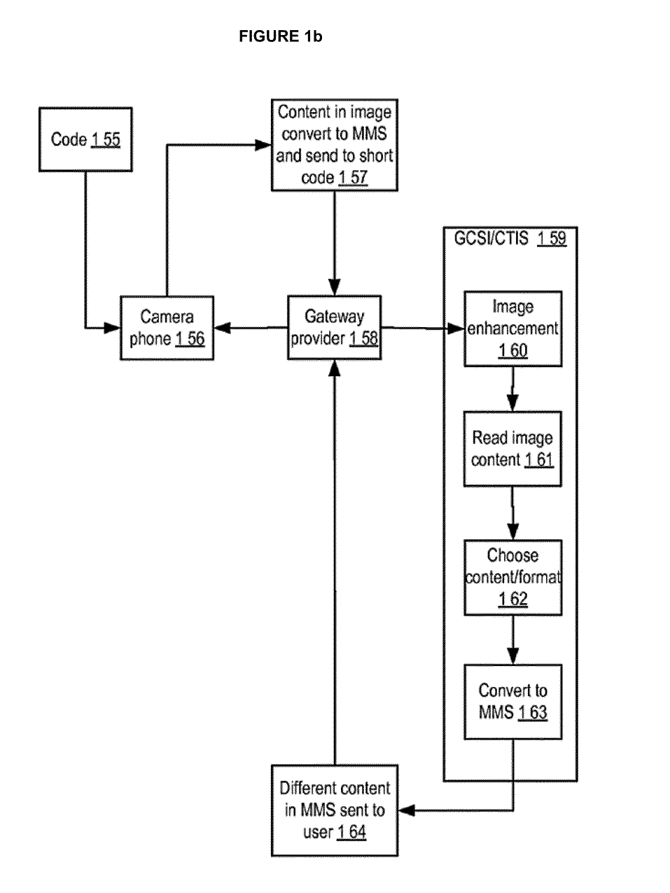

FIG. 1a shows a combined logic and data flow block diagram illustrating a general overview of the CTIS in one embodiment. The CTIS may be configured so that a user (100a) may scan a digital code (105) with a scanning device (100b), as for example by using a cell phone camera to scan and/or take a picture of a barcode, 2d code, matrix code, data matrix, QR code, or other such symbology. An example of a mobile device and software capable of such code capture is the Nokia 6600 cellular telephone equipped with ConnexTo software. Alternatively, the CTIS may be triggered by the user selecting an internet link (such as on an internet enabled mobile device), by making decisions within a virtual world (such as a massively multiplayer online game), and/or the like. Without loss of generality, all such forms of interest-registering CTIS triggering will be referred to as “code scanning”. The time and location (as determined by GPS, GPRS, or other such geo-positioning technologies) of the mobile device are determined (110), and a Scan Message (115) is generated containing a user identification (ID), a hardware ID that identifies the type of mobile device being used, a geocode (location of the device), a timestamp, and the scanned code (see, e.g., discussion of Scan Message below). Additional user-input information may also be supplied at this point. The Scan Message is packaged and sent (120) to a server (101) that receives and recognizes it (125). The user's profile, specific to the supplied user ID, is updated with the new Scan Message (i.e., it is added as a transaction to their profile transaction history) and queried (130) for information to use in the preparation of a Reply Message (140) that is also based on the content of the current Scan Message. The server selects (135) the Ad content of the Reply Message (145) from an Information Base and sends it to the user's mobile display device, which displays the pertinent content to the user (150).

### MMS

In one implementation, the Scan Message and/or data captured from the artifact may be sent to the server (101) by a Multimedia Messaging Service (MMS) protocol. In other implementations, a wide variety of other communication protocols may be employed, including but not limited to: Short Messaging Service (SMS), instant messaging, web browser based messaging, email, Enhanced Messaging System (EMS), TCP/IP, WAP, and/or the like.

### Common Short Code

In one implementation, the server (101) may be addressed by a short code, short numbers, Common Short Code (CSC), and/or the like for sending the Scan Message and/or scanned code. For example, a short code may appear alongside a code in a print publication, and a user may be informed that the scanned code should be sent to the indicated short code number in order to retrieve a Reply Message, advertisement, coupon, and/or the like. In other implementations, other addressing means may be employed, such as an ordinary telephone number, an email address, a universal resource locater (URL), and/or the like. In another implementation, the short code and/or other server address may be encoded within part of the code itself. When the user scans the code with his or her mobile device, the code may be partially decoded by the client device to extract the address and automatically send the rest of the code thereto.

### Artifact Data Capture

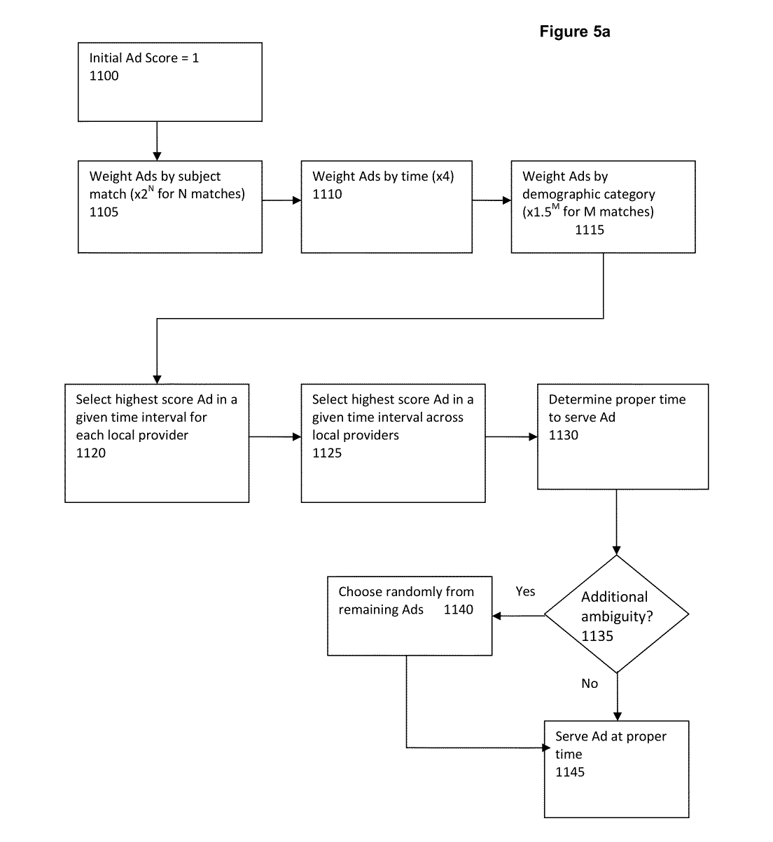

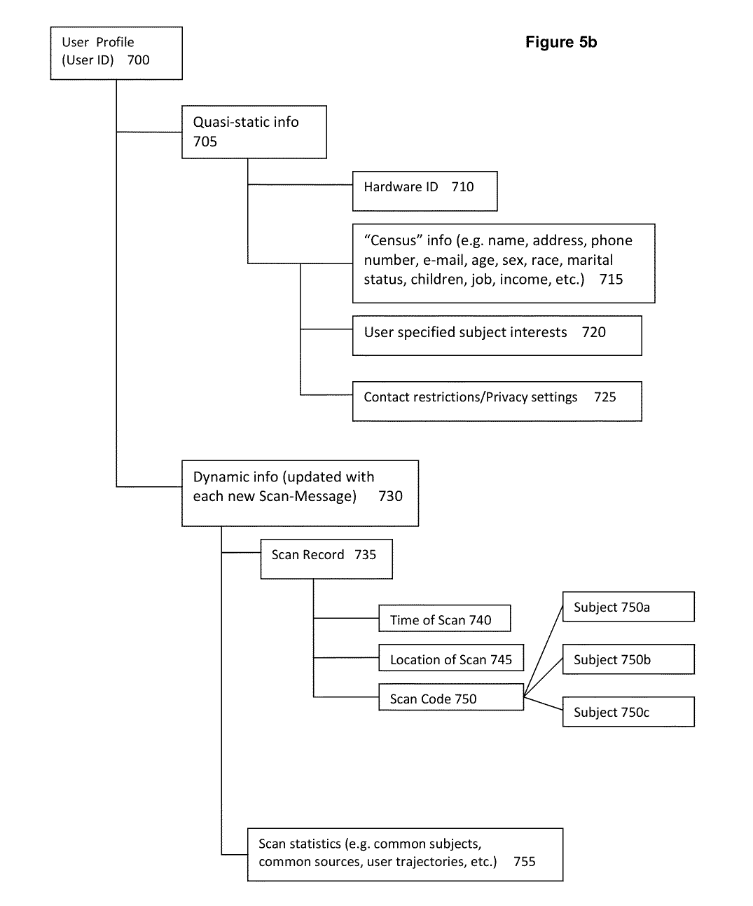

FIG. 1b shows an implementation of combined logic and data flow in another embodiment of CTIS operation. An artifact (155) is scanned by a camera phone (156), and the resulting image content is converted to an MMS format to be sent via short code (157) through a gateway provider (158) to the CTIS (159) server. At the server, the image information may be enhanced, manipulated, and/or otherwise processed (160) so as to aid in determining the appropriate content to serve in response. After enhancement, the image content is read (161) and the content and format for the appropriate response is determined (162) (see, e.g., FIG. 5a). A response message is formed in MMS format (163) and is sent (164) back to a gateway provider (158) to be served to the user's camera phone (156).

In an alternative implementation, the scanned artifact may be directly decoded on the client mobile device instead of on the server. The decoded content may then be converted to MMS format and sent via short code to the server in order to retrieve the appropriate content associated with the code. That content may be returned from the server to the client mobile device by means of an MMS protocol as well.

### Code Triggered Information Server (CTIS) Detailed Overview

### User and Ad Provider Participation

The CTIS may be enabled by the participation of Ad providers and users. In one embodiment, Ad providers supply Ads for storage on the CTIS server. In an alternative embodiment, the Ads are stored on third party servers that are referenced by the CTIS server. The user experience may be enhanced by the incorporation of personal preferences and demographic information to optimize the targeting of Ad content. Consequently, one embodiment would incorporate a user registration procedure. Users may register for the CTIS via the internet, telephone, postal mail, and/or the like. If a particular embodiment of the CTIS requires client software for the user to install, this could be supplied upon successful user registration. In an alternative embodiment, a basic user identification packet (e.g., a “cookie”) is sent with a user's first code scan, thus establishing a basic user profile that can be filled in with greater detail at a later time.

### Artifact Capture (105)

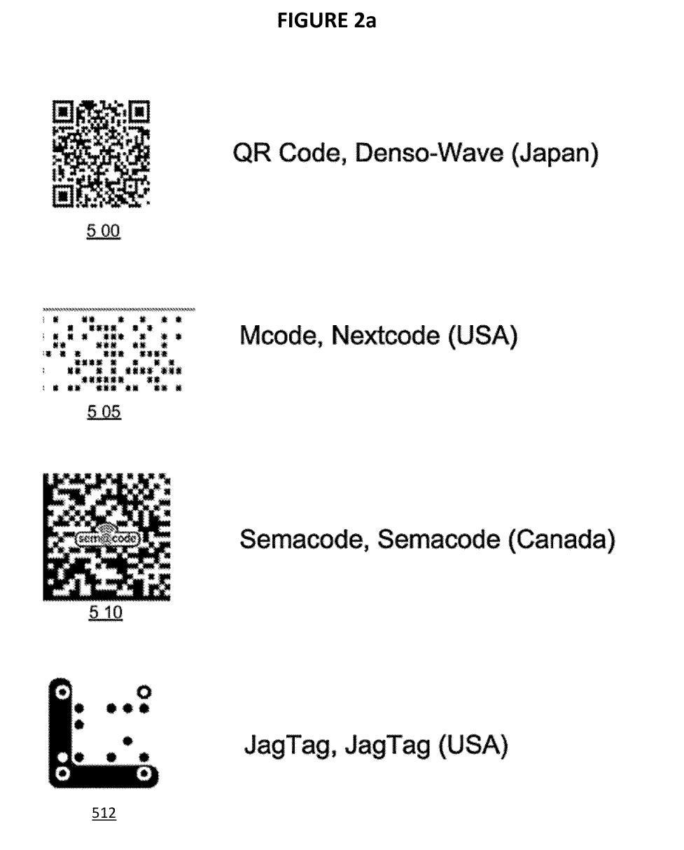

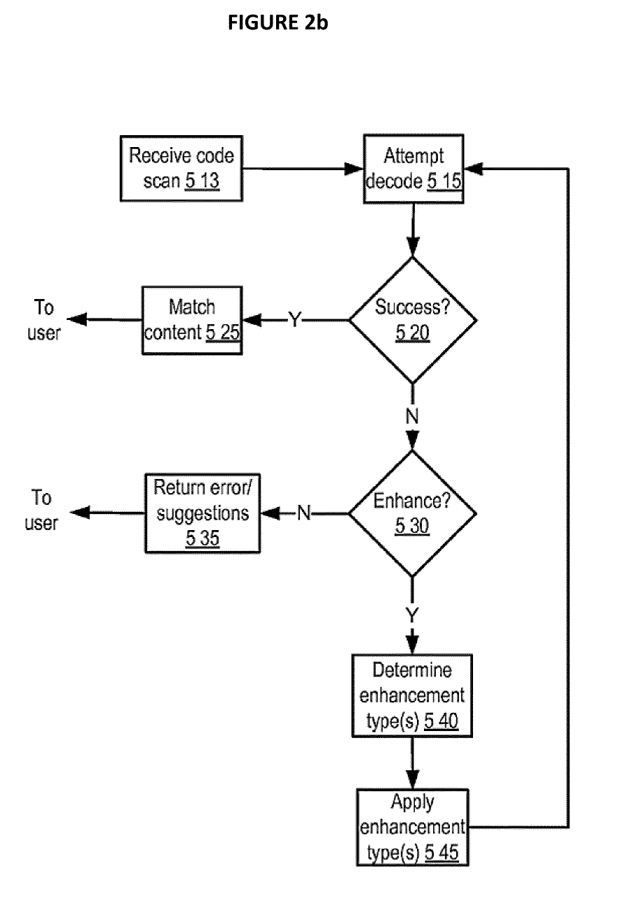

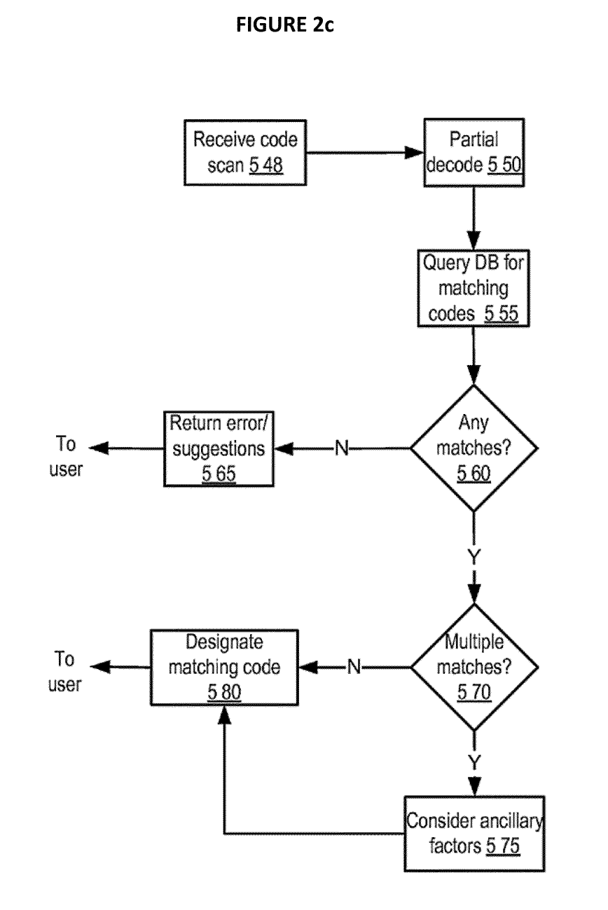

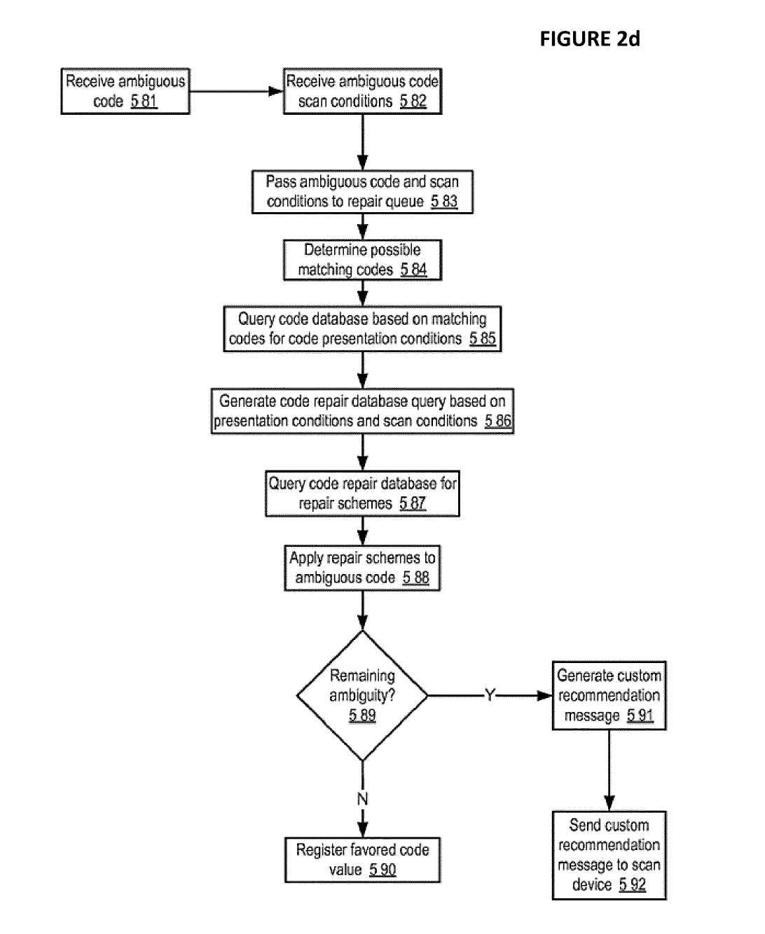

As noted above, artifacts may be any product, activity, service or media of interest to a user. Artifacts may be found in a variety of locations, including but not limited to newspaper and magazine articles, signs and billboards, flyers, store locations and kiosks, consumer products, packages, clothing, stickers, websites, software displays, television broadcasts, virtual worlds, geographic landmarks, e.g., buildings, topographical features, such as mountains or coastlines, and/or the like. The artifact may include a barcode which, itself, is scannable. As noted above, the nature of a bar code that may be scanned will depend to some extent on where the code is found, but among the possible types of codes are standard barcodes (e.g., UPC, EAN, Code 128, etc.), 2D matrix codes (e.g., QR code, Semacode, Data Glyphs, mCodes, etc.), user-input codes (e.g., text messages), RFID tags, pure images (e.g., an image of a sign to be analyzed by optical character recognition), website links, software inputs, and/or the like. These codes may be located on any medium (e.g., on newspapers, magazines, books, video content, computer screens, embedded in objects (e.g., RFID tags on clothes, etc.), and/or the like). One embodiment employs 2D matrix codes, examples of which are provided in FIG. 2a, due to their large data capacity, ease of scanning, and resilience to damage or error. These examples include QR codes 500, Mcodes 505, Semacodes 510, and/or the like. FIG. 2a also displays a fourth matrix code called a JagTag 512. The JagTag includes an aesthetically pleasing appearance and provides functionality that is more robust than other matrix codes. Further aspects of JagTag encoding are described in detail below.

### Code Enhancement

In scanning an artifact, the artifact image may not always be recorded faithfully and/or in an ideal and/or suitable condition for decoding and/or matching to associated content. Consequently, the CTIS may be configured to enhance and/or otherwise process an artifact image in order to better recognize the artifact. FIGS. 2b-c show implementations of logic flow for processing and/or managing non-ideal barcode scans in embodiments of CTIS operation. In FIG. 2b, a scanned barcode is received at the CTIS server (513) and a first attempt is made to decode a received barcode scan (515). In one implementation, a received barcode scan may take the form of a bitmap image and/or a compressed bitmap image. If the decoding is successful (520), then the barcode is matched to associated content (525) that is ultimately destined to be served to a user. Otherwise, a determination is made as to whether enhancement should be applied to the scanned code (530). If not, then an error message and/or suggestions on how to improve the quality of the scanned barcode may be returned to the user (535). The CTIS may decide not to apply enhancement, for example, if enhancement has already been applied unsuccessfully to the same image before or if the quality of the image is so poor as to be clearly beyond improvement. If enhancement is to be applied, then the CTIS determines the appropriate enhancement type (540) based, for example, on the quality and character of the scanned code image and subsequently applies the enhancement (545), after which a new attempt is made to decode the scanned barcode.

In some implementations, multiple enhancement processes may be applied against a scanned artifact and the results compared in order to determine the encoded content. Prior to enhancement, the image may be downsized if necessary for speed of processing in applying multiple enhancements against the image. Image quality may also be increased if necessary in order to more successfully apply enhancements. For artifact images having extraneous information and/or noise, an enhancement process may be applied to remove all extraneous information, despeckle, and/or the like. For artifact images having shades of gray and/or shadows obscuring the encoded content, an enhancement process may be applied to manipulate the contrast and/or brightness of the image in order to create a pure black and white image for cleaner decoding. For code images that are tilted and/or not taken flat in a plane, an enhancement process may be applied to tilt the plane of the code to create a flat plane to aid in successful decoding. For code images that are rotated or skewed, an enhancement process may be applied to de-rotate, deskew, and/or otherwise recreate proper rectangular pixel groupings that can be decoded. For code images that are taken out of focus, an enhancement process may be applied to sharpen the image into recognizable pixel groupings. Additionally, the CTIS may apply edge recognition processes to the code image to create a set of potential code images that can be processed and compared to records in a code database.

The artifact image may be presented, either in its raw captured or in its enhanced form, by displaying the image to the user for the user to validate the image content for the features of interest to the user. For example, where a user images a brand name, the user can validate that the brand name is visible, clear and readable. Additionally, the enhancement processes described above may further visually delimit or demarcate regions of interest to the user, such as outlining the brand name to further validate the area of interest to the user.

### Partial Decoding

In some cases in which full decoding of a scanned artifact image is impossible, a partial decoding may be accomplished and serving of content achieved on that basis. A partial decoding may, for example, result in a probabilistic artifact match without ever successfully decoding the complete artifact. FIG. 2c shows an implementation of logic flow for partial decoding in one embodiment of CTIS operation. A scanned barcode image is received (548), partially decoded (550), and the partially decoded content used to query a barcode database to find matching barcodes (555). A determination is made if any matches exist (560) and, if not, then the CTIS may return an error message to the user and/or make suggestions about how to improve the image of the scanned barcode (565). If a match is found, however, then a determination is made as to whether there are multiple matches (570). If so, then the CTIS may consider ancillary factors (575) in attempting to isolate a single code as the most likely match to the received code. Such ancillary factors may include, but are not limited to: the incoming phone number, the carrier, the time of day, current code traffic, the source of the code, the context of the code, the user ID, the hardware ID, the user behavioral history, the user location, and/or the like. In considering ancillary factors, the CTIS is thus capable of predicting the true code based on knowledge of the user scanning the code, the context of the code, ambient factors, and/or the like. Once a unique code has been identified, this is designated as the matching code (580) and the CTIS proceeds with determining the appropriate associated content to serve to the user.

FIG. 2d shows an implementation of logic flow for customized repair and/or decoding of obscure or ambiguous scanned codes. An ambiguous code may be received at a GCSI/CTIS [Should we remove reference to GCSI as previously discussed; otherwise we need to define it as the term seems to prevalent in text and drawings.] system at 581, such as may be sent via a communications network from a user's mobile scanning device. In one implementation, a scanned code may be qualified as an ambiguous code if an attempt to decode the code does not yield a single result. In one implementation, the system may also receive code scanning conditions 582 describing any of a variety of circumstances of the code scan which may affect the quality and/or fidelity of the scanned code. For example, some relevant circumstances may include the time of day, light levels, use of flash, mobile scanning device type and/or characteristics, code size, contrast, brightness, sharpness, skew, rotation, and/or the like. The ambiguous code and scan conditions may then be passed to a repair queue 583, whereby the system may analyze the ambiguous code and attempt to discern the correct decoded content. A plurality of possible matching codes are determined at 584, and a code database is queried at 585 to extract code presentation conditions corresponding to each of the plurality of matching codes. Code presentation conditions may describe how and where the code was displayed and may comprise a wide variety of factors, such as but not limited to medium (e.g., newspaper, glossy paper, product packaging, television display, website, billboard, and/or the like), likely obscuring factors (e.g., glass covering, tears, distance, and/or the like), and/or the like. The GCSI/CTIS system may then generate a code repair database query based on the presentation conditions and/or scan conditions 586 and query the repair database to extract repair schemes corresponding to the particular presentation and/or scan conditions. For example, a particular code repair scheme may be tailored for and/or correspond to codes displayed on billboards that are scanned after dark by Nokia mobile phones. Extracted repair schemes corresponding to each of the possible matching codes are applied to the ambiguous code at 588, and a determination is made at 589 as to whether any one of the possible matches is now more likely to be correct than the others. This determination may be made, for example, by measuring the fidelity of codes with various repair schemes applied and selecting as the correct code that which has the highest resulting fidelity. If no remaining ambiguity exists as to the correct code, then the favored code is registered with the GCSI/CTIS system at 592. Otherwise, the GCSI/CTIS may generate a custom recommendation message 590 and send the message to a user and/or a user's mobile device 591. The custom message may, for example, provide tailored recommendations on how the user may improve the fidelity of the code scan based on the possible matching codes and the associated presentation conditions and/or scan conditions. Tailored recommendations, as well as the repair schemes themselves, may be adjusted based on feedback received from users about which codes they were actually trying to scan. In one implementation, the GCSI/CTIS may provide a query message to a user presenting a summary of content associated with alternative matching codes in order to determine which content the user was actually trying to access. It should be noted that code analysis and/or repair may be undertaken on a code image level, alphanumeric string level, binary string level, and/or the like basis. Combinations of such bases may also be undertaken, such as by first analyzing the ambiguous code in its alphanumeric string form and then, if ambiguity remains, analyzing the code in its binary form. Further discussion on such an analysis is provided below.

In an illustrative example of partial decoding, a given matrix barcode may encode the string ABC123. In multiple processes, it may be determined that the code contains A_-1_{—}3 (where the blanks represent unknown values), _C1_, and AB_. Through these multiple processes, the CTIS system now knows that the barcode contains ABC1_{—}3 and may check this against codes in a code database to determine how many matches exist. If it finds two matching codes (e.g., ABC123 and ABC143), it may consider ancillary factors. For example, ABC123 may correspond to an advertisement for a new action movie while ABC143 corresponds to a coupon for women's cosmetics. If the user supplying the code is determined, based on a supplied user ID, to be a man with a history of scanning movie-related codes, then the CTIS system may infer that ABC123 is the matching code and serve the corresponding content. In one implementation, the CTIS server may further supply a confirmation request for partially matched codes, requesting the user to affirm or deny that the supplied content is, in fact, the content that he or she was seeking

Similarly, in a related illustrative example of partial decoding, an image of a cosmetic product is captured using a camera on a smartphone. The decoding processing is able to identify a square light green box with the letters _IN_Q_UE being recognizable in the image. The CTIS server in conjunction with the Information Base, may prompt the user for a product classification or to fill in the missing letter information manually. If the user is prompted for a product classification, a comparison with known cosmetic manufacturers may be undertaken from the Information Base and the user prompted to confirm that the product of interest is from CLINIQUE. Then further product information may be presented to the user based upon this validation of the product decoding.

### Scan Message Data Structure (115)

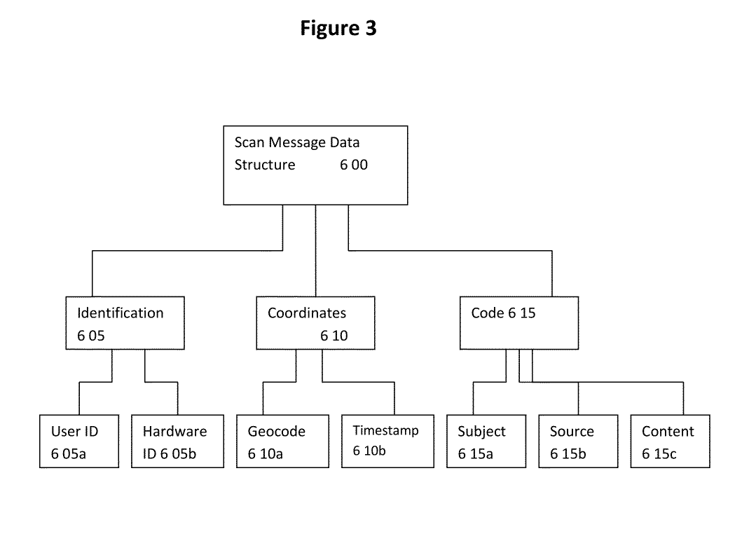

The Scan Message generated by the CTIS is, itself, a novel data structure. In one embodiment that is illustrated in FIG. 3, it contains an identification field (605) comprising a unique user ID (605a) and a hardware ID (605b), both automatically supplied by the device used to scan and transmit the scanned code; a coordinate field (610) comprising the location geocode (610a) (e.g., GPS coordinate, latitude and longitude, city and state, etc.) and timestamp (610b) of the scan; and a code field (615) supplying the specific content of the scanned artifact, which may include a subject code (615a) for the code context, a source code (615b) indicating where the code was located, and a content code (615c) indicating the specific information, if any, to be supplied in response to a scan of that code.

It will be understood by those skilled in the art, however, that certain elements of the data structure may or may not be required as part of the Scan Message. For example, in the present invention the location geocode may be considered optional or may be deduced in other, non-GPS methods from the scanned artifact data.

In one embodiment, the XML for the Scan Message takes the following form:

<Scan_Message>
<ID>
<User ID> 012305 </User ID>
<Hardware ID> Nokia 660 </Hardware ID>
</ID>
<Coordinates>
<Geocode> GPS 40 46.516 -73 57.98 </Geocode>
<Timestamp> 08/21/2006 13:45:28 </Timestamp>
</Coordinates>
<Code>
<Subject> entertainment; movies; comedy </Subject>
<Source> New York Times </Source>
<Content> Showtimes for latest popular comedy movie </Content>
</Code>
</Scan_Message>

### Data Transmission (120, 125, 145, 150)

In one embodiment, sending and receiving the Scan Message and Reply Message will employ standard data transmission techniques to ensure successful transmission and to preserve data integrity (e.g., TCP/IP, 1xEV-DO, etc.). This is relevant for the Scan Message, which will contain the coded information scanned by the user. Such techniques may include but are not limited to the use of standard transmission protocols, “handshaking”, data compression, data encryption, and error correction.

### User Profile Structure (130)

User profiling is an optional functionality of the present invention and may or may not be included in the data processing exchange between the user, the data capture device or computing device and the server. As shown in FIG. 5b, when a user profile (700) is optionally employed, the content of the user profile generated by the CTIS may itself a novel data structure and will contain a category of quasi-static user information (705) that is generally fixed over time and one of dynamic user information (730) that is updated with each successive Scan Message that the user submits. The quasi-static info (the “quasi” qualifier indicates that this information may be updated, for example if a user changes their mobile device, however it does not change with each successive code scan) may include a hardware ID (710); “census” info (715) such as name, address, phone number, e-mail address, age, sex, race, marital status, number and age of children, job title, annual income, etc.; subjects of interest specified by the user (720); and information regarding allowed methods to contact the user as well as user defined privacy and/or information sharing settings (725). In one embodiment, this information could be supplied by the user when registering for the GCSI/CTIS service as, for example, on a website. The dynamic info in the profile may include a scan record (735), comprising the time (740), location (745), and scan code (750) (including subject (750a), source (750b) and content (750c)); and statistics related to the scan history (755). In one embodiment, the profile contains a series of identifying codes distilled from the profile content (e.g., demographic category code based on census info, subject codes, source codes, etc.) that can be compared with similar codes in the Scan Message to determine the appropriate Ad content to include in the Reply Message. In an alternative embodiment, the profile contains identifying keywords or “tags” based on the profile content that can be compared with similar tags in the Scan Message to determine the appropriate content to include in the Reply Message. In both cases, the identifying labels for the user profiles may be input by CTIS administrators or automatically generated by an appropriate computer algorithm such as stripping header labels from ad descriptions (e.g., for example, stripping the header tags from an HTML ad).

In one embodiment, the XML for the User Profile may take the following form:

<User>
<Quasi-static info>
<User_ID>123-45-6789</User_ID>
<Hardware ID> Nokia 660 </Hardware ID>
<Census info> John Smith; 123 Maple Dr., Smalltown, CA 92676; (123)456-7890;
jsmith@email.com; 55 years; male; white; married; 2 children; etc.
</Census info>
<Interests> camping; fishing; classic cars; movies; etc. </Interests>
<Contact restrictions> Weekdays 8 AM - 7 PM only </Contact restrictions>
</Quasi-static info>
<Dynamic info>
<Scan record>
<Scan_#1>
<Time> 08/21/2006 13:45:28 </Time>
<Geocode> GPS 40 46.516 -73 57.98 </Geocode>
<Code>
<Subject> entertainment; movies; comedy </Subject>
<Source> New York Times </Source>
<Content> Showtimes for latest popular comedy movie </Content>
</Code>
</Scan_#1>
<Scan_#2>
etc...
</Scan_#2>
etc...
</Scan record>
<Scan statistics>
<Popular subjects> entertainment; cars; travel; etc. </Popular subjects>
<Popular sources> New York Times; Car and Driver; CNN.com; etc. <Popular sources>
<Trajectories> Data files listing time and geocode coordinates, computed average trajectories,
likely locations, etc. </Trajectories>
etc...
</Scan statistics>
</Dynamic info>
<Code>
<Subject> entertainment; movies; comedy </Subject>
<Source> New York Times </Source>
<Content> Showtimes for latest popular comedy movie </Content>
</Code>
</User>

In one embodiment, data accumulated in a plurality of user profiles may be analyzed to extract information about codes that are scanned. For example, the frequency with which a particular code is scanned may be extracted from user profiles and parsed by geographic, temporal, and/or demographic criteria to yield code profiling information. This information may be stored in a code and/or Ad profile. In an alternative embodiment, the code/Ad profile may be constructed and/or updated by the CTIS immediately upon the receipt of a Scan Message rather than being extracted from user profiles.

### Information Base (135)

### Artifact Searching

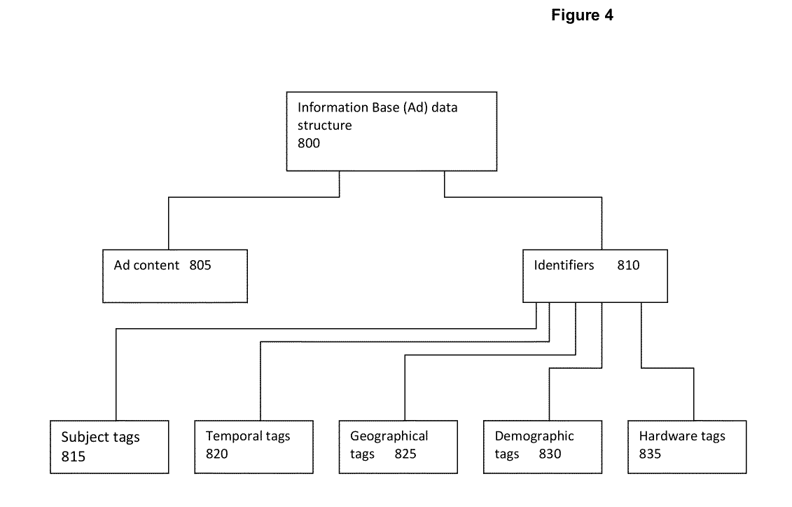

The Information Base contains the content that may be included in the Reply Message sent to the user and may be stored on the CTIS central server or on third party servers accessed by the CTIS. In one embodiment, each Ad is associated with searchable labels. The Ad content together with its labels, collectively referred to here as an Ad, forms a novel data structure. In one embodiment illustrated in FIG. 4, the Ad (800) is comprised of the specific ad content (805) (e.g., text, images, video, etc.) and a set of identifiers (810) including subject tags (815), information characterizing the temporal character of the Ad based on which the Ad may be triggered (820) (e.g., 6 to 10 AM for a breakfast Ad), information characterizing the geographic specificity of the Ad based on which the Ad may be triggered (825), demographic specificity of the Ad (830) (e.g., an Ad for family vacations), and the hardware requirements of the Ad (835) (e.g., hardware IDs of devices capable of displaying the content of a particular Ad). In one embodiment, the Ad would also contain information identifying the source in which the Ad code is to appear. In another embodiment, the Ad would also contain code/Ad profile data, describing the history and/or statistics of scans related to the Ad.

Alternatively, the Information Base 135 may serve as a gateway to obtain specific ad content (805) from remote sources accessible on a distributed network of servers, such as over the Internet.

Like the CTIS Database, the Information Base 135 may be may be centralized or decentralized and distributed across multiple server sites or reside entirely within a Cloud Computing Environment (the “Cloud”). Further, the Information Base 135 may consist of multiple information resources distributed across the Internet or in the Cloud, and may, for example, include various search commercial engines such as GOOGLE, YAHOO SEARCH, BING or the like as data look up resources and pointers to URLs for artifacts or artifact information of putative interest to a user.

In one embodiment, the XML for an Ad may be in the following form:

<Ad>
<Ad_ID>123</Ad_ID>
<Ad content>
textual movie showtime listings ( or images, audio, video, URLs, etc.)
</Ad content>
<Identifiers>
<Subject> entertainment; movies; comedy </Subject>
<Temporal> 08/21/2006; 12:00:00 to 14:00:00 </Temporal>
<Geographic> Smalltown, CA 92676 </Geographic>
<Demographic> 17 years and older </Demographic>
<Hardware> any (text only) </Hardware>
</Identifiers>
</Ad>

### User Profile Query (130)

### Static Content and Dynamic Content in Reply

The CTIS queries the user profile to determine which Ads to include from the Information Base in the Reply Message in order to tailor those Ads to the user's profile characteristics, interests, and trajectories. In one embodiment, a scanned code will yield two components in the Reply Message content: i) static content that is the same for every user who scans the code, and ii) dynamic content that depends on the context of the user and the user profile. The static content (i) is determined from the scan code, while the dynamic content (ii) is determined by a combination of the scan code and the user profile, requiring a dynamic content generation heuristic to combine their respective influences. While a variety of such heuristic are possible and contemplated as being within the scope of this disclosure, and the specific heuristic employed in a given realization will likely depend on the precise application and intention. An example of one embodiment of heuristic useful with the present invention is found in commonly owned U.S. Published No. US2011/0264527A, which is hereby incorporated by reference, in its entirety. Some other possible methods may include alternative ordering of filters, addition or removal of filters, weighted filtering, complex conditional trees, and/or the like.

### Consumer Targeted Merchantile Information

In one embodiment, the CTIS allows advertisers to supply product information in a virtual world to the consumers who would be most interested in such ads; this may be achieved by the CTIS selecting advertising content based on a combination of the context of the code that the consumer scanned, the consumer's stated interests as recorded in his or her user profile, the consumer's demographic profile, a decision made within a virtual world, situational information, and a record of scanned codes and/or virtual world decisions; these factors can be analyzed and employed by the CTIS for both user tracking and behavioral profiling/targeting. For example, a player in The Sims Online who frequently acquires new furniture for his/her virtual apartment and has a stated interest in modern art may be served advertisements for an actual furniture store that sells modern furniture and is near the user's geographic location following one such virtual furniture acquisition. In another example, a user in Second Life that likes modern clothing for his/her character may be presented with ads on virtual billboards from advertisers of virtual in-game clothing stores that are nearby the user's virtual position (or offer a virtual transportation link that will instantly move the user's avatar to the virtual in-game store).

The CTIS delivers targeted Ads to users in a virtual world while simultaneously providing detailed customer tracking information to Ad providers. The CTIS supplies Ad providers with greater precision and focus to provide consumers with the information that is most relevant to their interests, behavioral patterns, and space-time and/or virtual world trajectories to maximize the possibility of consummating a transaction. In one embodiment, the CTIS is designed to allow advertisers to place ads at virtual world locations at specific times of the day such as to increase the likelihood of garnering the attention of prospective customers. In another embodiment, the CTIS yields time and virtual world location resolved records of scans for the determination of coded advertisement visibility. In another embodiment, the CTIS provides rapid and evolving virtual world geographic and historical statistical profiling of user interest and coded advertisement quality. In another embodiment, the CTIS provides an expanded platform to supply large quantities of information and content with a minimal amount of publication space.

From the user point of view, the CTIS provides a mechanism by which, in exchange for officially registering interest and providing basic information, he/she can receive the most targeted solicitations, enhanced content, sales offers/coupons, and/or the like within a virtual world. User benefits include: relevant and targeted advertising; mobile context specific information; contiguous location and/or immediate event information; coupons and/or offers for many types of goods and services; and/or the like.

At the same time, the system grants the advertiser a powerful tracking tool, to monitor behavioral patterns of consumers on individual, demographic, temporal, and virtual world geographic scales. This allows, among other things, the deployment of anticipatory advertising: serving advertisements to users in anticipation of their locations and/or potential interests based on an accumulated history of user tracking data. Other Ad provider benefits include: compilation of highly specific customer tracking information, including customer virtual world trajectories; virtual world location and/or time specific advertising; highly flexible coded advertising placement; quick and updated determination of coded advertisement visibility; and/or the like.

Of benefit to both users and Ad providers is the fact that users improve the specificity of their Reply Messages with each successive scan, since each scan further refines the contents of the user profile. Users thus have a motivation to scan as many codes as possible related to subjects of interest and will thereby be exposed to more advertisements than in more traditional, passive advertising and marketing schemes.

Ad providers participate by contributing content to an Information Base that categorizes and labels that content under a number of considerations, such as subject matter, virtual world geographic and temporal identity, demographic specificity, and/or the like. Elements of the Information Base can then be compared via these labels with comparable labels found in a database of user profiles in order to match content with users via subject, virtual world location, time, demographic category, and/or the like. As such, the CTIS efficiently facilitates commerce by providing advertising to consumers with highly tailored specificity.

### Querying and Serving Information on the Internet

In an embodiment, the CITS delivers information on the internet based on user activities, such as may be registered by codes scanned by mobile devices or website links selected on a computer, as well as user characteristics and an accumulated history of user activities. For example, information and/or advertisement providers may use CTIS to serve context, demographic, and behavior targeted information to users on the internet. In particular, information and/or advertisements are served on the internet that is targeted to the individual based on the individual's characteristic profile, behavioral patterns, and present contextual surroundings, either in real space of cyberspace. For example, a web-based advertisement may be provided on an internet enabled mobile device for goods and services located near a mobile user, which advertisement is selected based on the user's behavioral patterns and stated interests.

In one embodiment, the CTIS allows advertisers to supply product information on websites to the consumers who would be most interested in such ads; this may be achieved by the CTIS selecting advertising content based on a combination of the context of the code that the consumer scanned or the web link that the user selected, the consumer's stated interests as recorded in his or her user profile, the consumer's demographic profile, situational information, and a record of scanned codes or web links; these factors can be analyzed and employed by the CTIS for both user tracking and behavioral profiling/targeting. For example, a user with a stated interest in running and a recent pattern of scanning codes related to shoes may be served a web-based advertisement on his/her internet-enabled mobile device for a new running shoe being sold at a nearby shoe store. In another example, a user profiled to be a teenager and having a pattern of browsing websites related to comic books may be served a web-based ad for the newest comic book themed movie when he/she visits a movie-listings website

Users, in turn, trigger the provision of information by scanning or observing codes or information, or by selecting web links. The triggers, together with geographic, temporal, and user-specific information, are obtained by the server that receives, processes, and records the message. Based on these messages and a user profile—which may include continuously updated user-specific behavior information, situational and ambient information, an accumulated history of trigger messages, and integration with outside database information—the server selects information to serve to a user on the internet from an information base.

For example, a user with a recorded history of interest in coffee products may be served an advertisement for a nearby coffee shop while browsing the web on his/her PDA. In one embodiment, information may also be served to users on the internet based solely on the user profiles, and without any initiating trigger. This is based on user trajectories or web-surfing habits deduced from the accumulated history of triggers. For example, a user known to routinely visit a music vendor website near the same time each day may be served an advertisement for the latest top-selling CD shortly before that time.

Selecting the proper Ad to serve to the user in the non-triggered Ad serving embodiment of the GCSI/CTIS may be accomplished using a variety of heuristics that are best tailored to suit the specific use or application. Nevertheless, we present an example of a specific embodiment in FIG. 5a for illustrative purposes. In this embodiment, a weighting system may be employed to select among the Ads of a specific Ad provider once it is established that an Ad from this provider is to be served to the user. This weighting system begins by assigning a score of 1 (1100) to all Ads in the Information Base corresponding to the provider. This score is multiplied by a subject coefficient (1105) for every match between the Ad subject and the user specified subject interest or scan subject history. That coefficient is 2 in the present example, so N matches would yield a weighting factor of 2^{N}. The Ad score may also be multiplied by a time coefficient (1110) if the serving time falls within a time range specified for a particular Ad. In the present example, the time coefficient is 4, expressing the greater importance of this factor compared to a single subject match. Finally, the Ad score may be multiplied by a demographic coefficient (1115) for every match between the Ad demographic category and that of the user. That coefficient is 1.5 in the present example, reflecting the diminished importance of this factor compared to the time and subject considerations. M demographic category matches will yield a weighting factor of 1.5^{M}. Once all of the Ad provider's Ads are scored in this fashion, those Ads with the highest scores for that provider may be selected over the rest (1120). Similarly, the highest scoring Ads from other providers are selected and the highest scoring Ads over all providers can be selected to serve for a particular time interval (1125). Finally, the proper time to serve the Ad (e.g., 30 minutes prior to the expected average provider zone breach time) is established (1130) and, if there is no further ambiguity (1135), the proper Ad is served at that time (1145). Any residual ambiguity may be resolved by selecting randomly from the remaining Ads (1140).

### Applications of CTIS to Artifact-Based Shopping

The GCSI/CTIS provides a targeted information serving system that may be applied to a wide variety of shopping experiences and marketing and information dissemination applications. In one embodiment, the GCSI/CTIS creates enhanced ads with content that cannot be included in a print ad. For example, a user who scans an automotive-related artifact is provided additional content pertaining to the automobile such as detailed images, video, audio, reviews, and links to additional information, vendors, alternative automobiles of potential interest to the user, pricing information, specials or offers from different vendors, etc. If a geocode is provided in the Scan Message, the GCSI/CTIS may provide a list of local dealerships, special offers and pricing.

In one implementation, coupons may be supplied to a user's mobile device with digital rights management (DRM) software included to prevent or discourage coupon copying, sharing, and/or the like. In another implementation, no DRM software is included with the coupon.

In another embodiment, the GCSI/CTIS allows for reduced use of printed space in media publications. For example, an ordinary printed article or advertisement may be supplanted by a 2D matrix code that supplies the content directly to the user's mobile display device. Furthermore, the supplied content may be dressed with additional content that is specifically chosen for the user based on his/her profile or current location, thus increasing the value and utility of the content while still utilizing significantly reduced print space. This increased content value, coupled with the reduction in print space, may translate to significantly increased advertising revenue for media publications. In another embodiment, scan codes may be placed in web-based ads so that users may scan those ads with their mobile device. In another embodiment, scan codes may be placed in television-based ads.

In another embodiment, the GCSI/CTIS provides a means to supply urgent or breaking information. For example, a breaking news story that arrives too late to be included as a printed article can still be incorporated into a publication via a 2D matrix code. Publications could even have a permanent code in each issue that users can scan in order to access timely breaking and/or supplemental news for which there was a lack of space or time to include in the printed publication.

In another embodiment, the GCSI/CTIS provides a means of disseminating targeted information over a large scale. For example, during a widespread emergency, multiple artifacts may be broadcast over the television, including a single 2D matrix code, emergency video, an emergency sound, scrolling emergency banner, or the like. When users scan a given artifact displayed on the television, they are supplied with regional information/instructions, shelter locations, maps, etc. Certain users may be provided even more specific instructions if, for example, their profile lists their occupation as some form of emergency personnel. In an alternative embodiment, the GCSI/CTIS can provide targeted information to any or all users expected to be in the vicinity of a particular area or event based on their history of space-time trajectories. For example, if a chemical spill occurs and users are projected to be in the vicinity of it, a prior warning to avoid the area can be broadcast to the users' mobile devices. In an alternative embodiment, traffic alerts can be broadcast to the mobile devices of users projected to be in the vicinity of a high-traffic area before they are stuck there. The GCSI/CTIS may supply targeted Ads, including coupons, for nearby businesses, restaurants, coffee shops, etc. to these users for them to solicit while they wait for traffic to disperse. In general, just as the GCSI/CTIS can provide information to users about where they should go (e.g., Ad provider locations), it can also warn them to stay out of areas that they should not go, all based on the projected user trajectories.

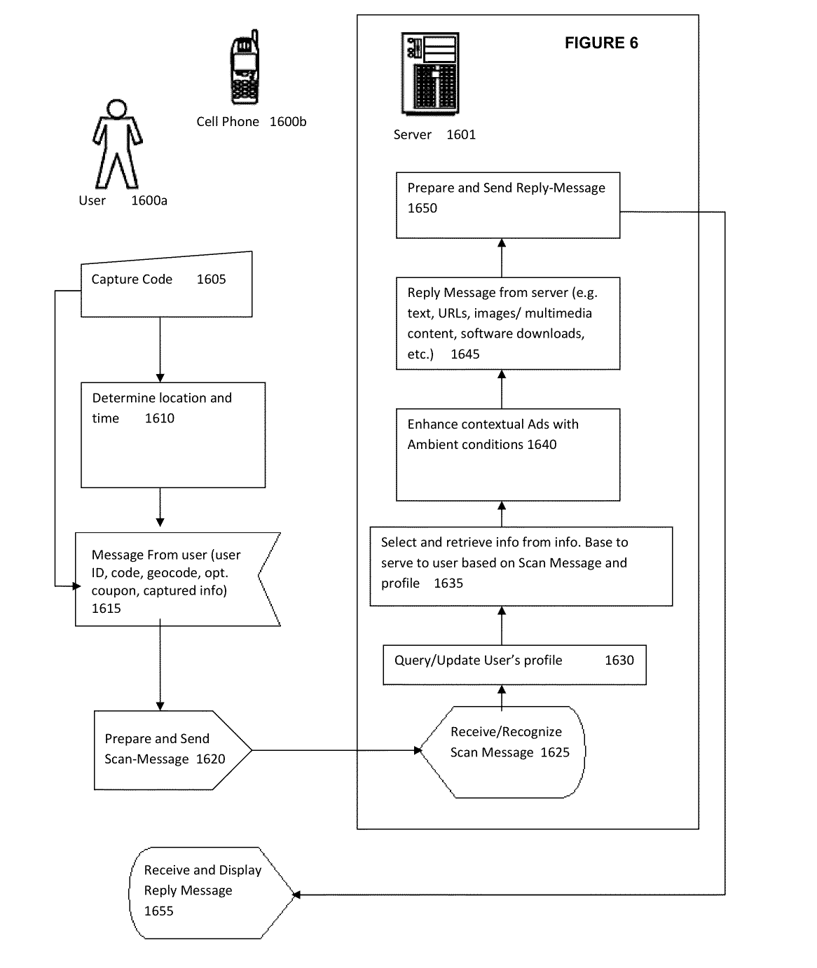

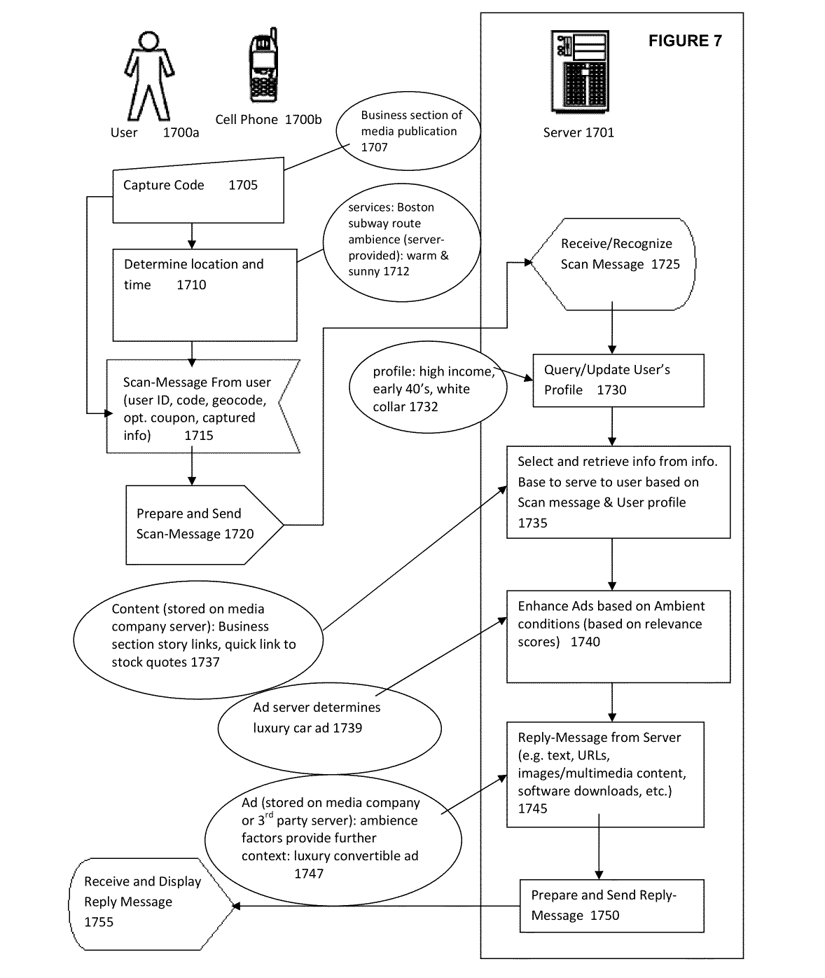

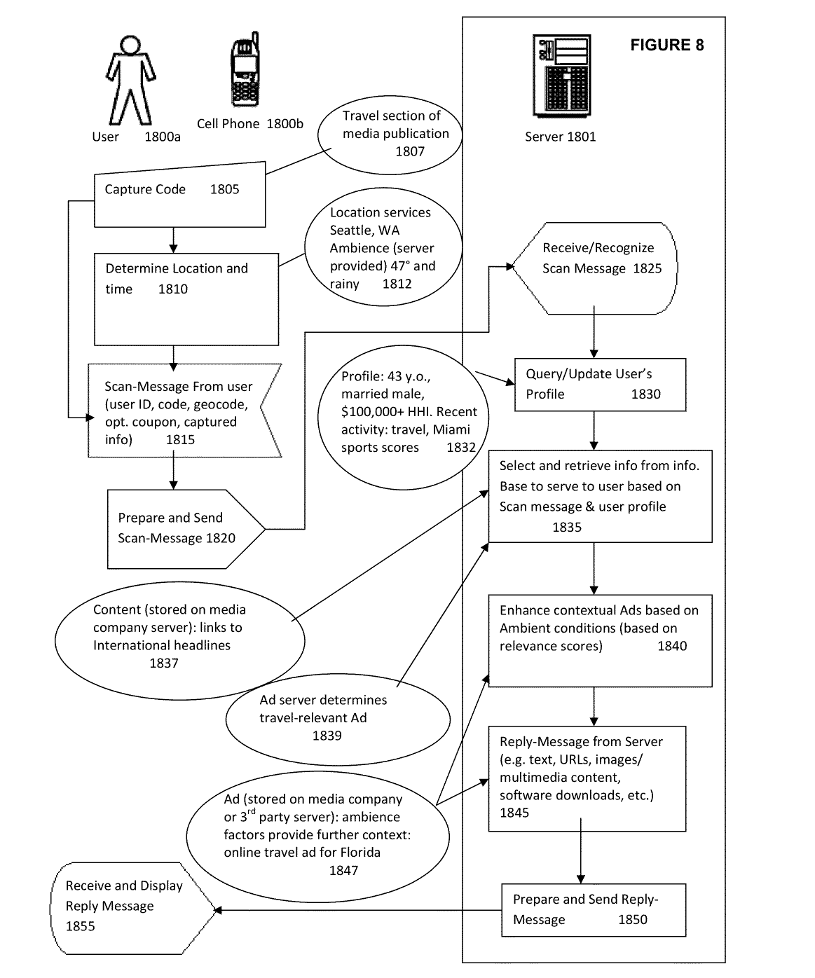

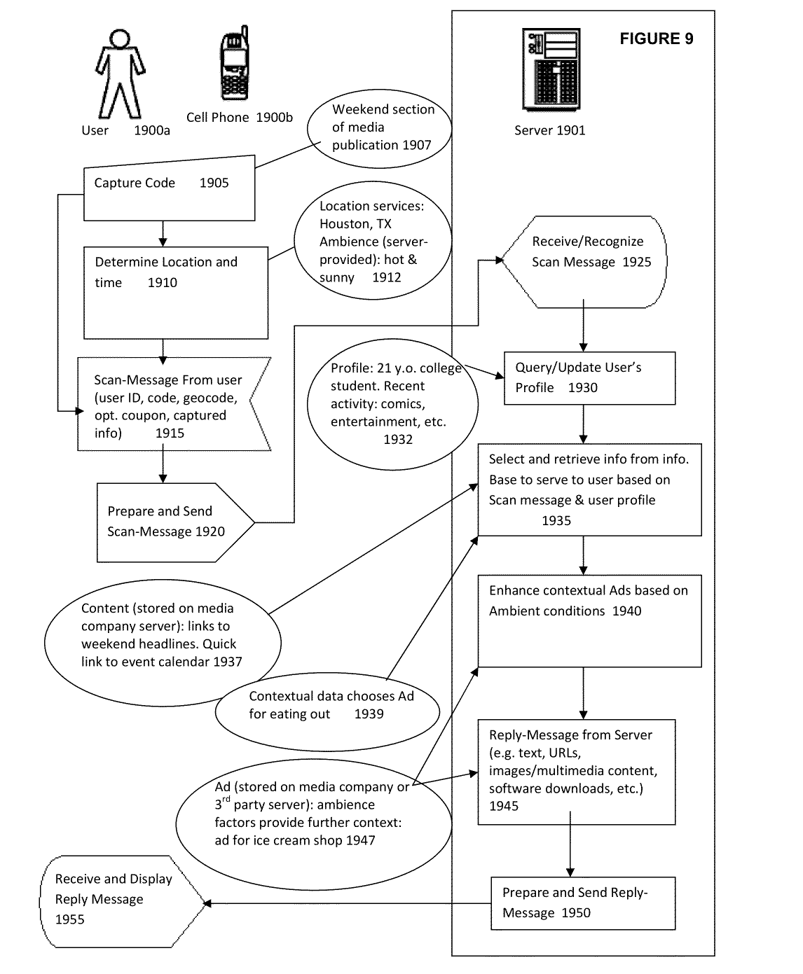

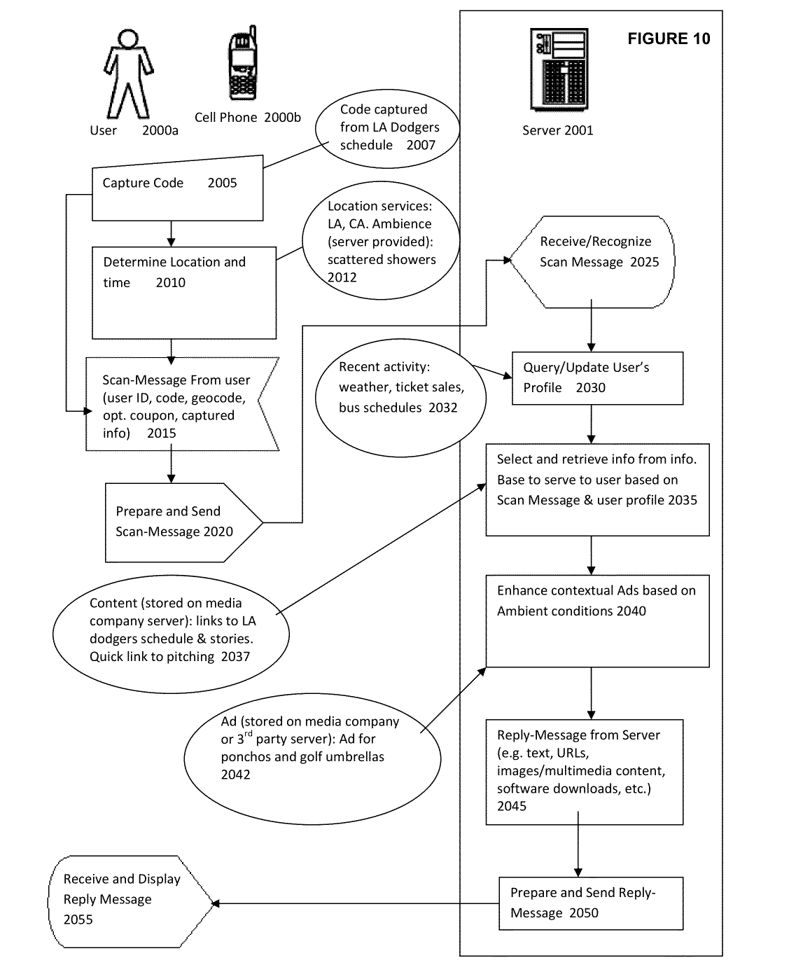

FIG. 6 shows a general embodiment of the GCSI/CTIS wherein the selection of contextual Ads is influenced by ambient conditions. Exemplary embodiments are provided in FIGS. 7-10. In FIG. 7, an artifact is scanned from the Business section of a media publication 1707 and the GCSI/CTIS selects luxury car Ads for display 1739 based on the scanned artifact, user location, and user profile 1732, and these Ads are further refined based on the ambient weather conditions provided to the server at 1712. In this case, warm and sunny weather provides further context to cause the GCSI/CTIS to serve an Ad for a luxury convertible 1747. In FIG. 8, an artifact is scanned from the Travel section of a media publication 1807 and the GCSI/CTIS selects travel Ads for display 1839 based on the scanned artifact and user profile 1832, which includes recent scan artifact transactions pertaining to travel and Miami sports scores. The GCSI/CTIS consequently queries the prevailing ambient weather conditions, comprised of cold and rainy weather, and supplies an Ad for Miami travel opportunities. In FIG. 9, an artifact is scanned from the Weekend section of a media publication 1907 and the GCSI/CTIS selects a contextual Ad for eating out 1939 from the Information base 1935 to serve based on the scanned artifact and the prevailing ambient weather conditions, which are hot and sunny 1912. This Ad is further refined by the user profile contents 1932 indicating a college student interested in comics and entertainment, and an Ad for an ice cream shop is finally supplied 1947. In FIG. 10, an artifact is scanned from a baseball team schedule within a media publication 2007. Based on the prevailing ambient weather conditions, including scattered showers 2012, the scanned artifact, and the recent activity in the user profile 2032, an Ad is supplied for ponchos and golf umbrellas 2042.

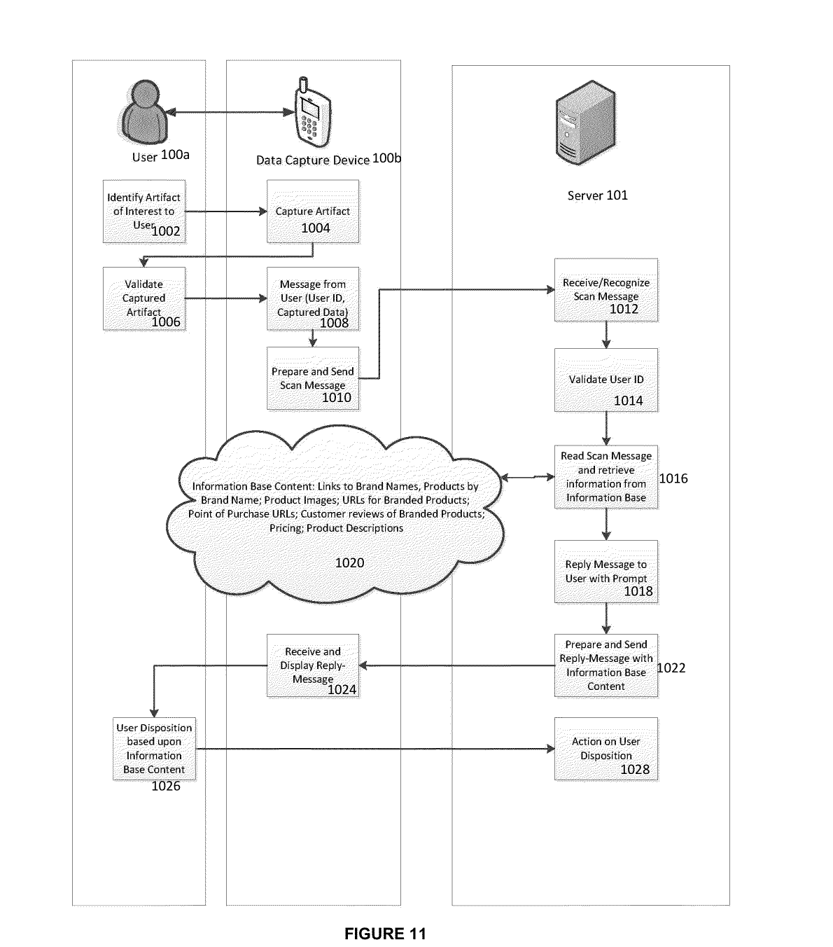

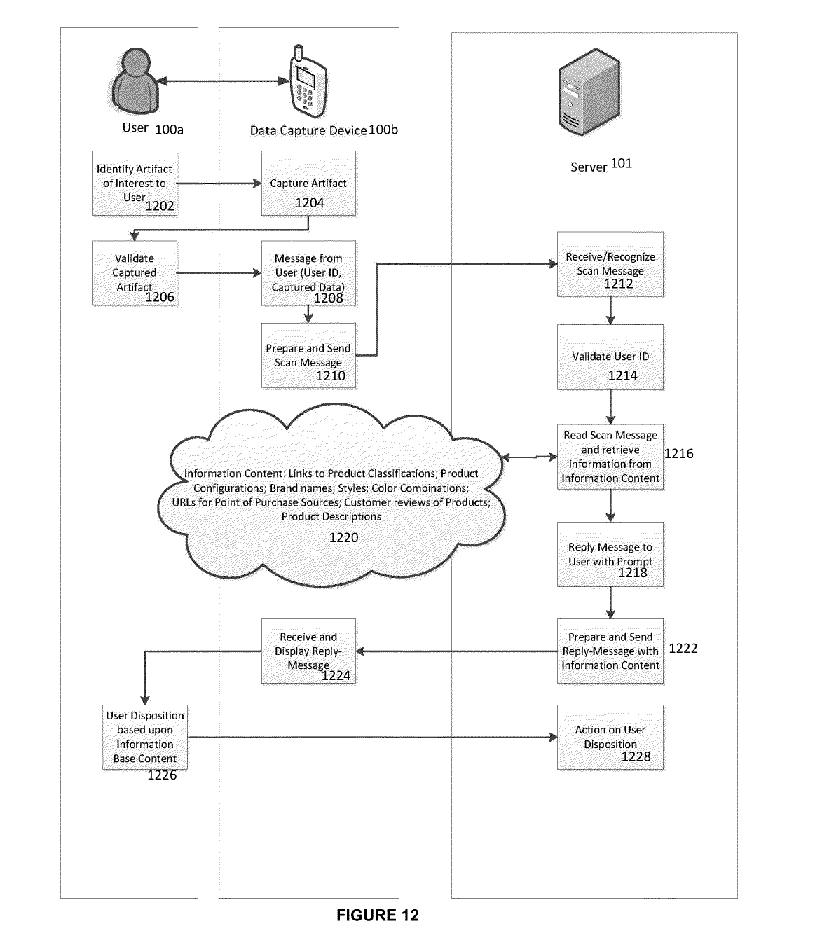

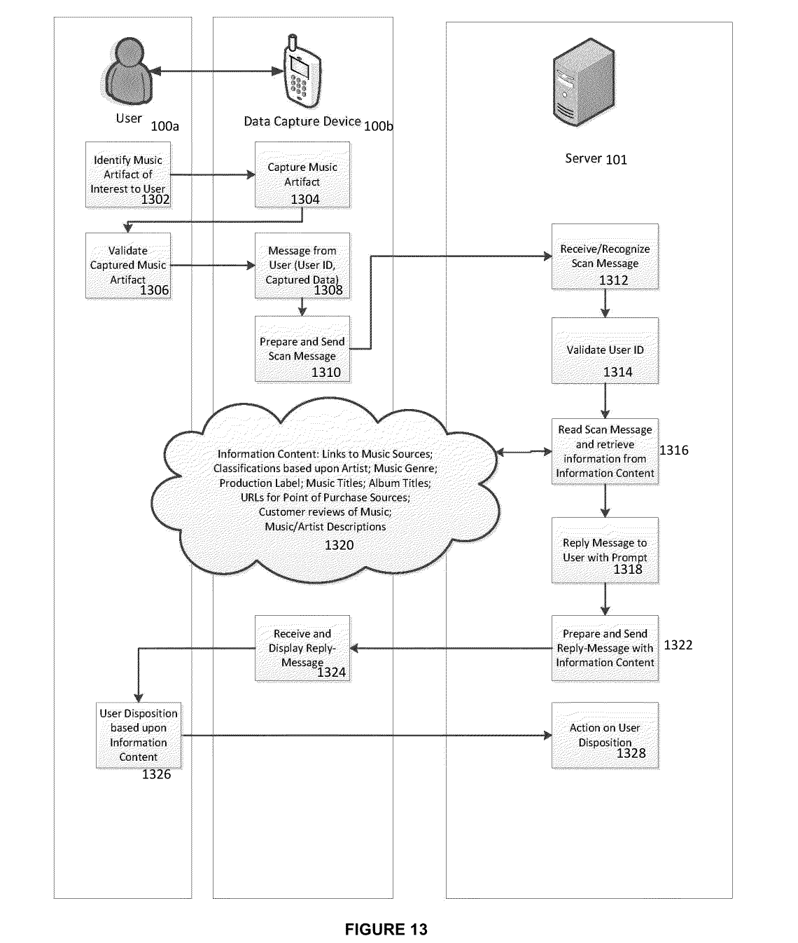

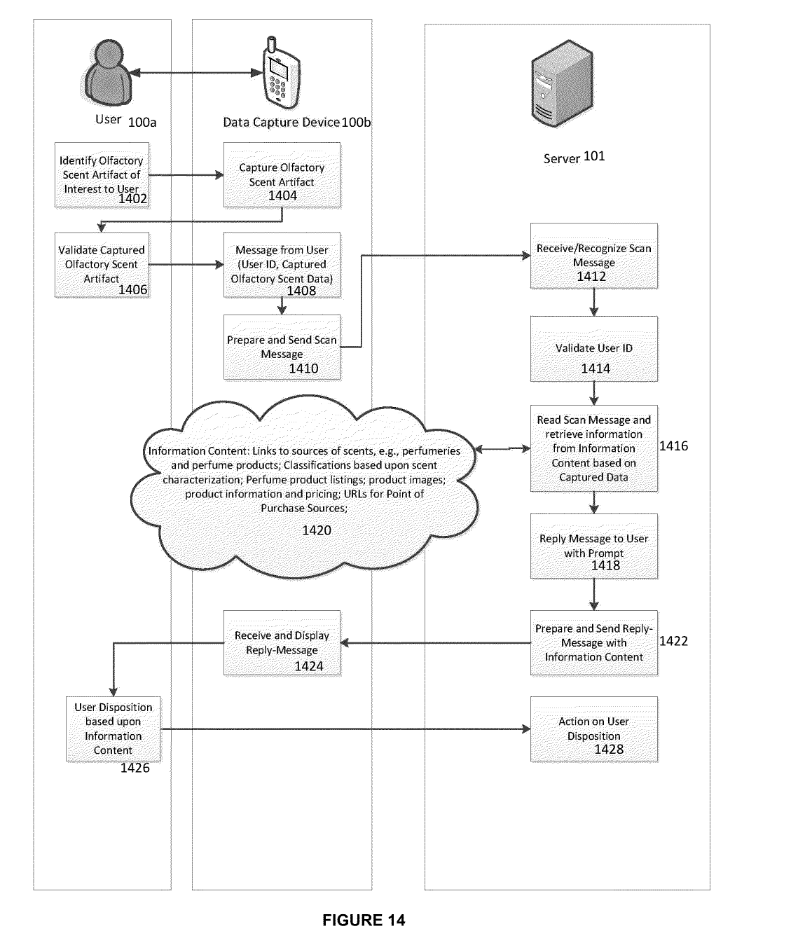

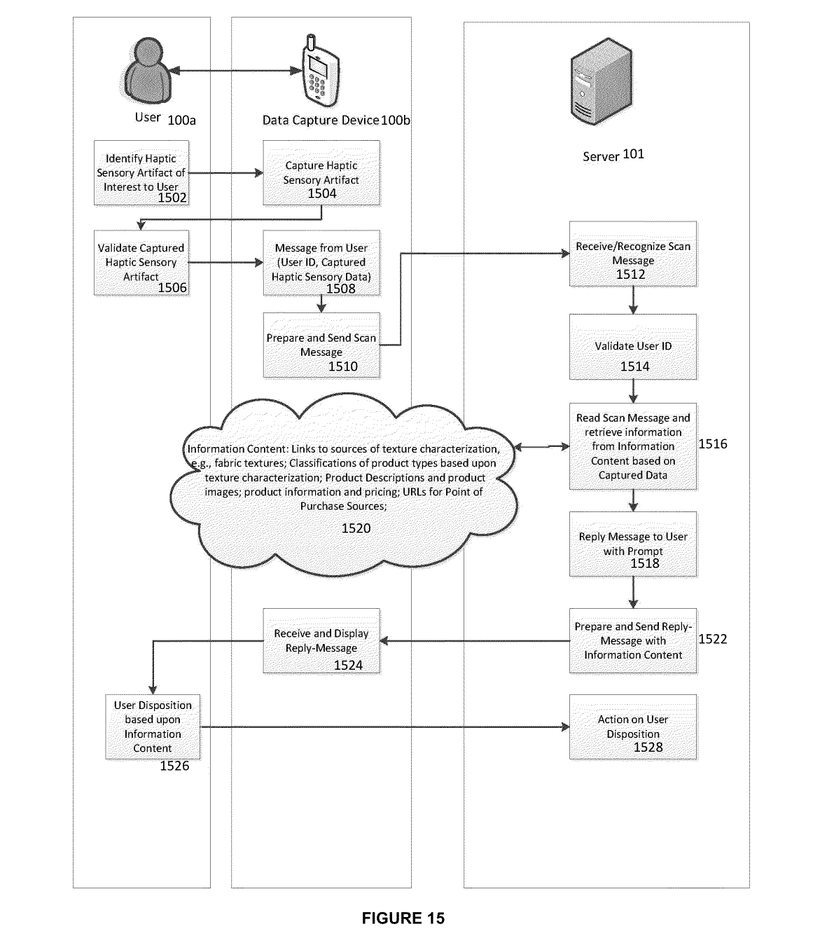

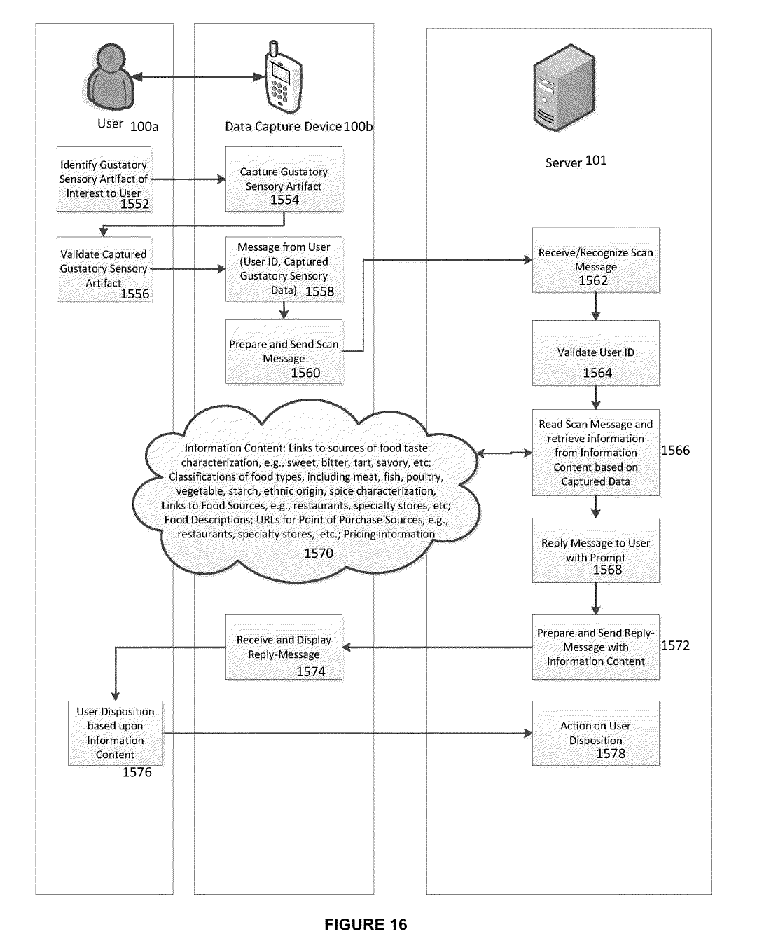

In FIG. 11, a user 100a identifies an artifact of interest in the user's environment 1002, captures the artifact using a data capture device 1004, e.g., a smartphone, and validates the captured artifact on the data capture device 1006. A message is formulated 1008 with at least some of the captured data and sent as a scan message 1010 to a server 101. The server 101 receives and recognizes the scan message 1012, validates 1014 the user 100a and reads the scan message 1016 to retrieve information from the information base content 1020. Based upon the captured artifact data, brand names in the captured artifact are compared with the Information Base Content 1020 and a reply message is formulated with a prompt to the user 1018 based upon the information obtained from the Information Base 1020. A reply message is formulated with the information base content 1022 and sent to the user 100a who receives and displays the reply message 1024. In the reply message the user is prompted for what type of further information, e.g., other products by the same brand, product images, point of purchase sites, product descriptions, etc. may be provided to the user in a Reply Message for action or disposition by the user. In response to the prompt, the user dispositions the reply message based upon the information base content 1026 and, if required, initiates an action based upon the user's disposition 1028 at the server. FIGS. 12-16 are similar to FIG. 11, except that in FIG. 12, the artifact is a product configuration and the Information Content returns product-based selections to the user 1220. In FIG. 13, the artifact is a music artifact and the Information Content is music-related 1320. In FIG. 14, the artifact is an olfactory scent artifact and the Information Content is scent-related information 1420. In FIG. 15, the artifact is a haptic sensory artifact, and the Information Content is product or material texture related content 1520. Finally, in FIG. 16, the artifact is a gustatory sensory artifact, such as a food product, and the Information Content is food or beverage related taste information 1570.

In one implementation, a GCSI/CTIS server may query, store, and/or consider data pertaining to media demographics associated with a particular medium in which a code is published; the subject content associated with a code; the type of information requested by scanning a code; and/or the like. For example, a user scanning a code associated with a product review for a hybrid sports utility vehicle (SUV) in a men's magazine may trigger a GCSI/CTIS system to draw and/or analyze data pertaining to media demographics associated with the men's magazine, subject content associated with hybrid vehicles (i.e., environmentally conscious consumers), subject content associated with SUVs (i.e., outdoor activity or families), and product reviews. Thus, the GCSI/CTIS may be configured to consider both the subject of a user's inquiry, the source of the inquiry, the type of inquiry, and/or the like.

In various embodiments, the GCSI/CTIS may serve Ads based on a wide variety of different ambient and/or situational conditions that may be detected by the client mobile device, provided by internal or third party databases or information feeds, and/or the like. Some non-limiting examples of potential ambient and/or situational conditions that may be considered and/or employed in selecting information to serve are temperature, weather, light levels, UV levels, pollen count, humidity, air quality, prices of commodities and/or consumer goods, stock and/or financial index prices, global and/or local news events, internet activities, sports scores, entertainment news, security warnings, and/or the like. Consideration of such factors, by themselves or in conjunction with knowledge of a user such as may be gleaned from a user profile, may form the basis of information serving rules that have great specificity of targeting. For example, a marketer rule within the GCSI/CTIS may specify that an Ad for participating bars that includes a coupon for a particular brand of beer be served to all male users between the ages of 21 and 40 with a history of scanning baseball-related codes within three hours of any time that the local baseball team wins a game. In another example, a marketer rule within the GCSI/CTIS may specify that an Ad for hybrid vehicles be served to all mothers with young children who have a history of scanning codes in Time magazine whenever the local price of gasoline is greater than $2.50/gallon and they scan a code in an issue of Time that contains articles on both global warming and the Iraq War. Such hyper-targeted information serving, enabled by the GCSI/CTIS, may prove very valuable to marketers and, in fact, to a wide variety of information dissemination applications. Advertisers may be able to purchase Ad time and/or impressions that are conditional on events, people, time, place, ambient conditions, and/or combinations thereof, and/or the like. Consequently, a premium may be charged to advertisers for each Ad served, and that premium may increase with the number of factors considered in serving the Ad (i.e., the degree to which the Ad serving is targeted). In another implementation, a different price may be charged per impression depending on the characteristics of the individual to which the Ad is served. For example, the hybrid car Ad described above may cost an advertiser $0.75 for an impression to a mom with adult children but $1.00 for an impression to a mom with young children. Such graded pricing schemes may be specified within a marketing rule data structure.

In another embodiment, Ads may be served based on internet “climate”, such as serving Ads for virus detection software during an outbreak or serving Ads for high-speed broadband internet service on days of high intern et traffic. Conditions for specific websites (i.e., cyberspace-time positions) could even be taken into account. For example, an Ad for high-speed broadband internet service could be supplied to visitors of a website experiencing particularly high traffic.

In another embodiment, the GCSI/CTIS may interface with various customer information databases, customer relationship management databases, and/or any other third party data sources in order to extract information that may be used to provide Ad content or further target and/or refine Ad selection for a given user. In one implementation, a marketer may supply the GCSI/CTIS with access to a given marketer-specific database and/or data feed, in order to allow the GCSI/CTIS to access the information therein during Ad selection processes. It should be understood that the functionality described for this embodiment of the GCSI/CTIS may be integrated or employed within any of the other GCSI/CTIS embodiments described herein.

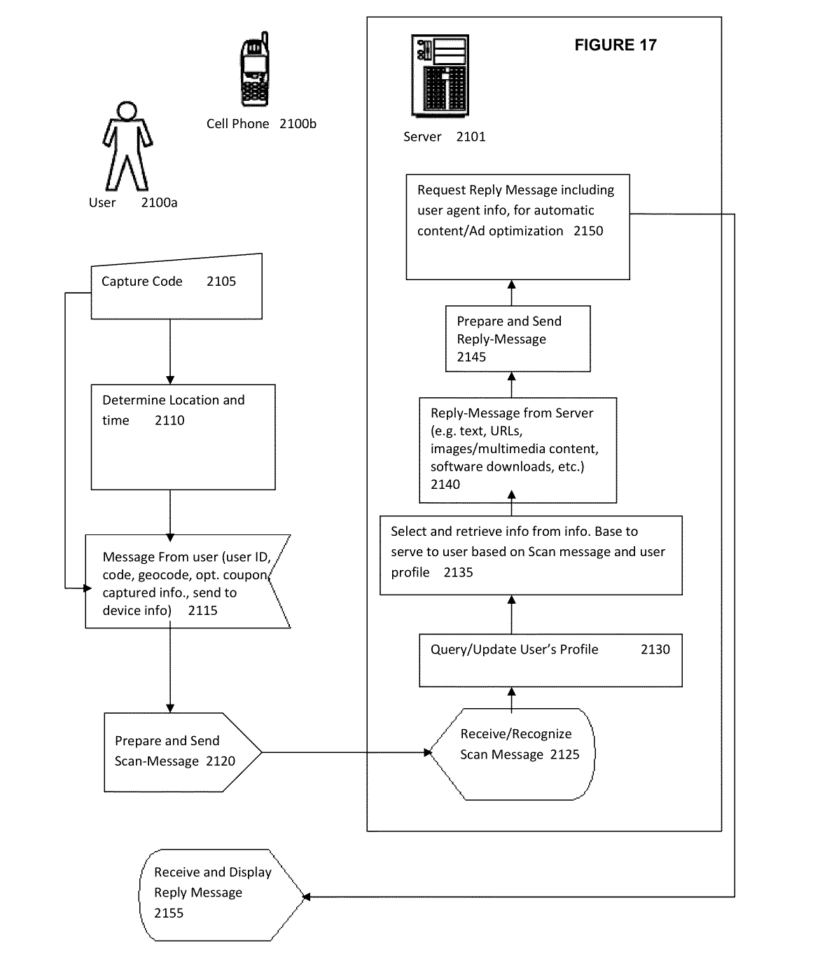

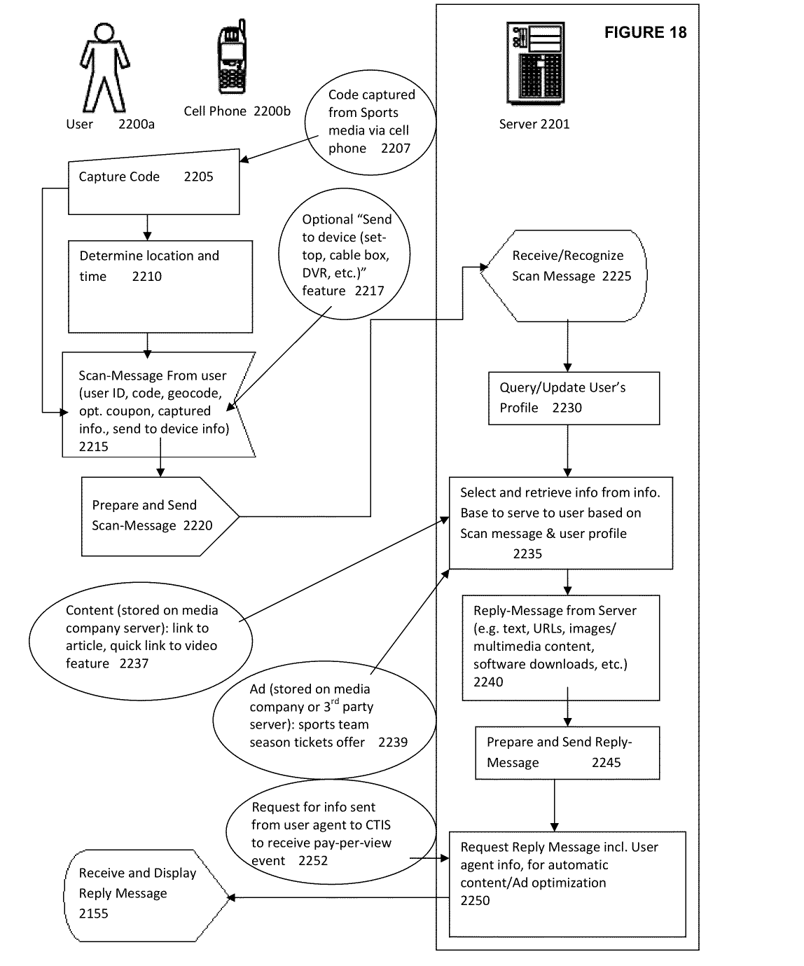

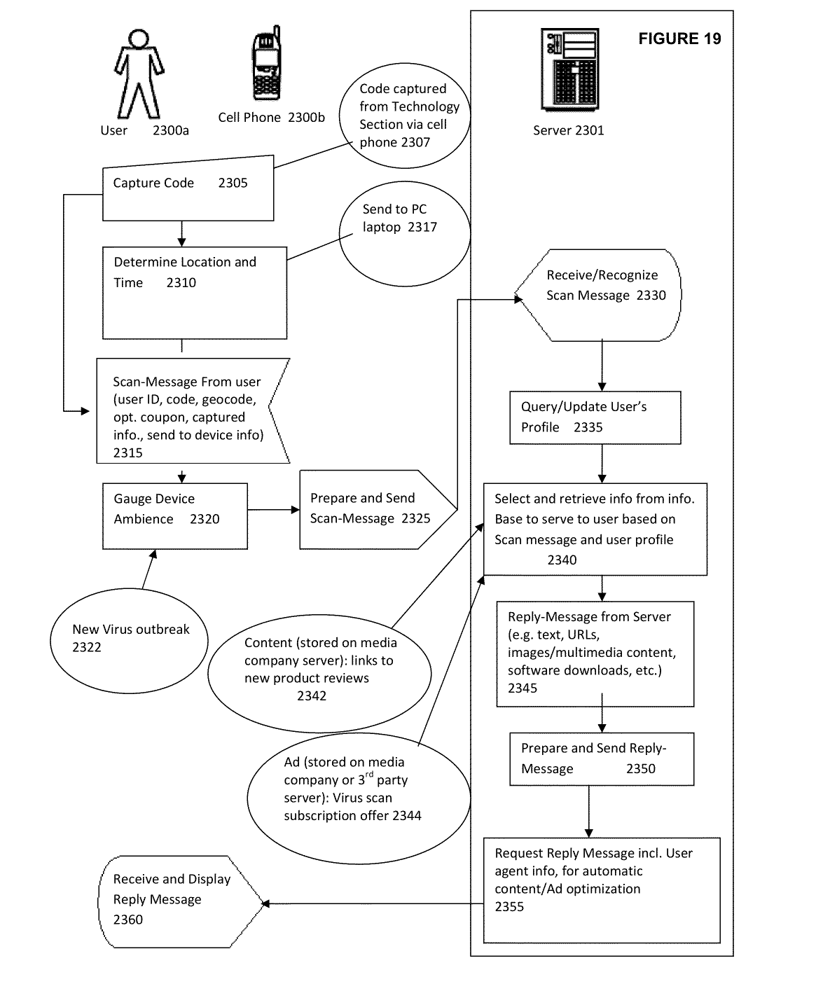

In another embodiment, the GCSI/CTIS can interface with and optimize Ads for various User Agent devices, which may include PCs, laptops, PDAs, DVRs, cable boxes, internet-coupled media devices, and generally with programmable electronic devices possessing external data transfer capabilities and/or the like. FIG. 17 provides an illustration of the logic and data flow in one embodiment. At 2115, the Scan Message content further incorporates an optional Send to Device info, which specifies the destination User Agent device for a particular Ad. Then, at 2150, the Ad content selected by the GCSI/CTIS is configured and/or optimized for the User Agent device. Exemplary embodiments are provided in FIGS. 18 and 19. In FIG. 18, a code from a sports publication is scanned by a cell phone 2207, and a set-top-box/cable box/DVR User Agent device is specified in the optional Send to Device information of the Scan Message 2217. Consequently, in addition to contextual Ads supplied to the user's cell phone containing article/video links 2237 and season ticket offers 2239, additional content is configured and sent to the User Agent device, such as authorization to descramble a pay-per-view sporting event. In one embodiment, the user's mobile device would provide a signal to the User Agent device to cause it to send a Request for Info to the GCSI/CTIS. In another embodiment, the GCSI/CTIS could send an appropriately configured signal to the User Agent device without the need for a Request for Info signal. In FIG. 19, a code is scanned from the Tech section of a media publication using a cell phone 2307, and the optional Send to Device info in the Scan Message specifies to send to a PC laptop 2317. In accordance with the ambient conditions embodiment discussed previously, the GCSI/CTIS gauges the ambient conditions associated with the device and determines that there has been a recent outbreak of a particular computer virus over the internet 2322. Consequently, the GCSI/CTIS supplies an offer for Virus Scan software subscriptions 2344, and may send Virus Scan software directly to the specified PC laptop based on user response.

### Artifact Serving Interface

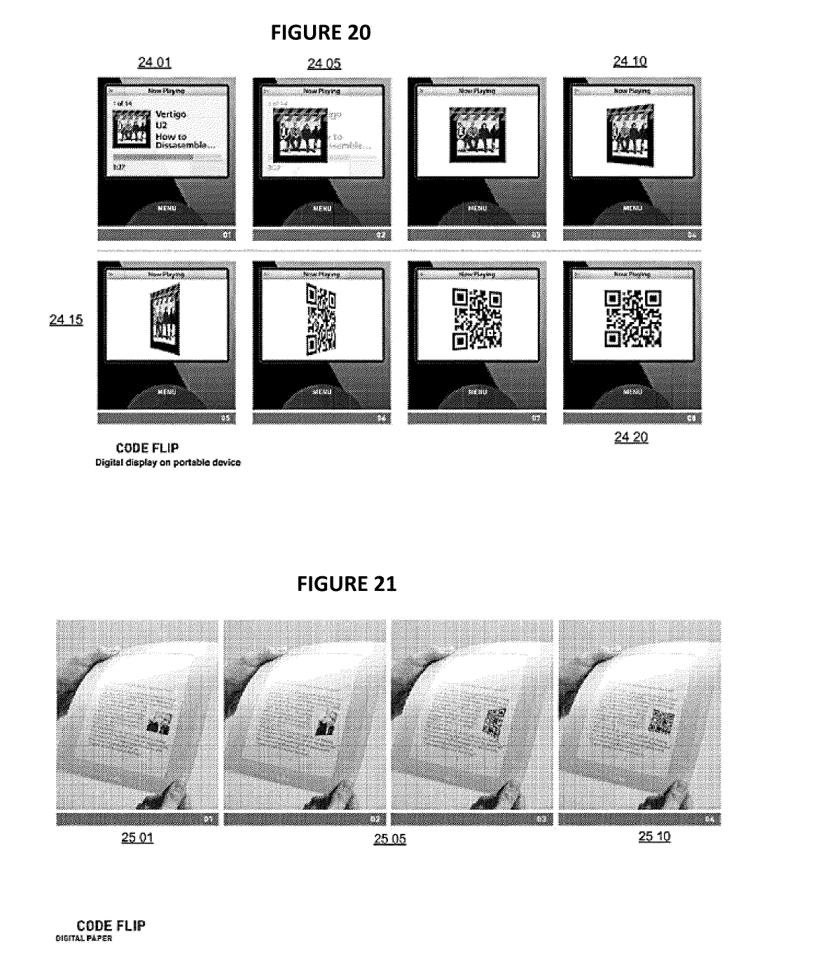

Serving artifacts to users may be accomplished by a variety of different means and in a variety of different contexts. FIGS. 20-25 illustrate some implementations of artifact serving interfaces in embodiments of the GCSI/CTIS system. In these implementations, a graphical display and/or interface initially presents a first visual token for display. This first visual token may comprise virtually any image, picture, drawing, emblem, icon, logo, animation, and/or the like representative of an artifact being displayed to or selected by a user. This first visual token may then be animated to reveal a second visual token comprising a second artifact, which may be encoded information, such as a QR code, matrix code, bar code, another image, picture, drawing, emblem, icon, logo, animation or the like. Animation of the first visual token may, for example, comprise rotation of the first visual token to reveal the second visual token on a proximate side of the first visual token. For example, a two-dimensional picture in the graphical display may rotate in the third dimension to reveal a matrix code on the back of the picture. Other forms of animation may also be employed within different implementations. For example, the first visual token may dissolve, morph, disassemble and reassemble, and/or the like to reveal the second visual token. In some implementations, the animation of the first visual token to reveal the second visual token may occur only in response to some user interaction with the first visual token. For example, a computer screen may display a first visual token persistently until a user clicks on the first visual token with a mouse pointer, at which time the first visual token may rotate to reveal the second visual token on its back. In another example, an electronic billboard may persistently show an advertisement until a motion sensor detects someone walking by, at which time the advertisement dissolves to reveal a matrix code underneath. In still another example, an electronic sign may display a particular image until a detector coupled to the sign detects a signal and/or an authorization code from a compatible, portable electronic device near the detector, at which time the image may morph into a barcode. In still another example, the first visual token displayed on a touch-sensitive display may flip over to reveal a code when a user touches it with a finger or runs a finger over it to simulate a flipping motion.

FIG. 20 shows an implementation of a user interface manifesting GCSI/CTIS functionality on a portable electronic device in one embodiment of GCSI/CTIS operation. A wide variety of different portable devices may execute and/or coordinate with GCSI/CTIS functionality, such as but not limited to portable media players, cellular telephones, IPHONES, BLACKBERRIES, IPADS, PDAs, and/or the like. In the illustrated implementation, a portable media player displays album information, including an image of the album cover, on a graphical display, where the displayed information corresponds to music being played on the player 2401. A user may register interest by entering a click on or otherwise select the album cover image, causing it to increase in size 2405 and rotate 2410-2415 to reveal a matrix code or other related artifact on the image 2420.

FIG. 21 shows an implementation of a user interface manifesting GCSI/CTIS functionality on digital paper in one embodiment of GCSI/CTIS operation. Here, an image is included in one area of an article displayed on the paper 2501. Either by itself or in response to some user action, the image flips 2505 to reveal the artifact on its other side 2510.

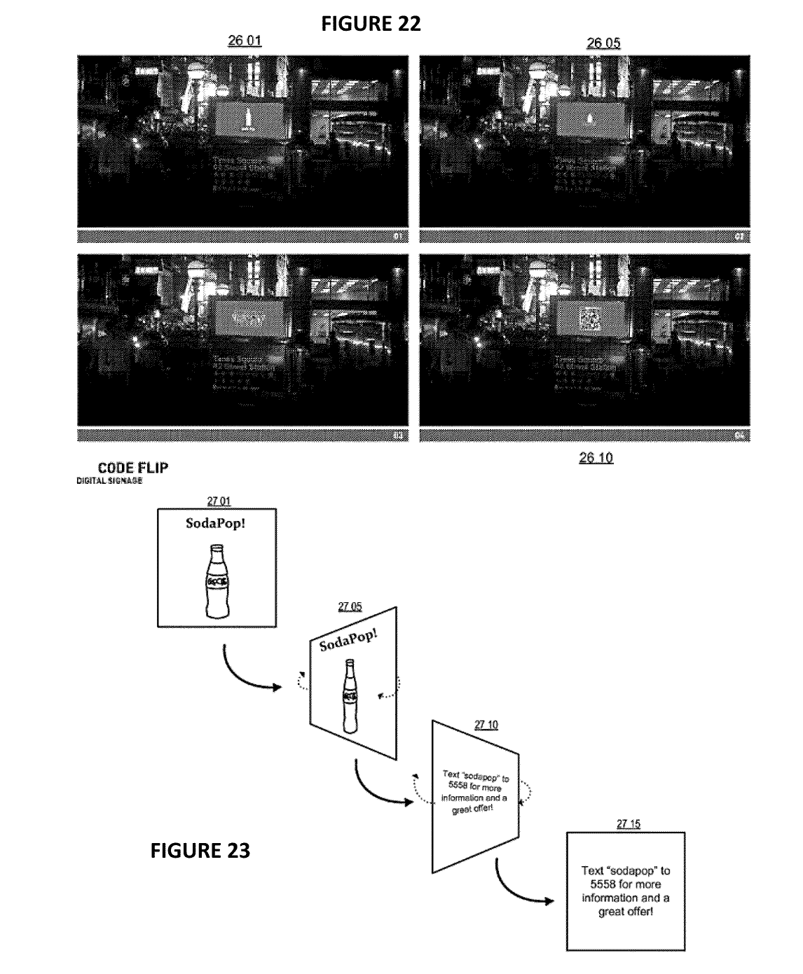

FIG. 22 shows an implementation of a user interface manifesting GCSI/CTIS functionality on a digital billboard in one embodiment of GCSI/CTIS operation. A public, electronic billboard display shows an advertisement comprising a product logo 2601. The product logo artifact rotates 2605 to reveal a matrix code artifact on its opposite side 2610. Flipping of the logo may occur periodically or aperiodically, upon detection of a nearby viewer, upon detection of a portable device capable of decoding the matrix code artifact, and/or the like.

FIG. 23 shows an implementation of a user interface manifesting GCSI/CTIS functionality for serving an SMS text message prompt in one embodiment of GCSI/CTIS operation. A first visual token 2701 shows an image and text, such as may correspond to an advertisement, logo, and/or the like. The token may appear in a wide variety of contexts, such as on a website, in a virtual world, on a cell phone or other portable communications and/or media device (e.g., Blackberry, iPhone, iPod, and/or the like), on an electronic billboard, on broadcast television or recorded video content, and/or the like. The first visual token may be animated, such as by flipping, rotating, revolving, and/or the like (2705, 2710), to reveal encoded content on a proximate side thereof. In the implementation illustrated in FIG. 23, a message appears along with an SMS code that a user may key in to an SMS enabled communication device to receive associated content. In alternative implementations, other types of codes and/or code communication protocols may be displayed and/or employed for communication with GCSI/CTIS systems, such as but not limited to: MMS, instant messaging, web browser based messaging, email, Enhanced Messaging System (EMS), TCP/IP, WAP, and/or the like. For example, a first visual token may be animated to reveal an email address, website address, instant message nickname, and/or the like on a proximate side to enable a user to connect to and/or communicate with a GCSI/CTIS system and/or affiliated entity for the receipt of information, coupons, offers, advertisements, media, and/or the like.

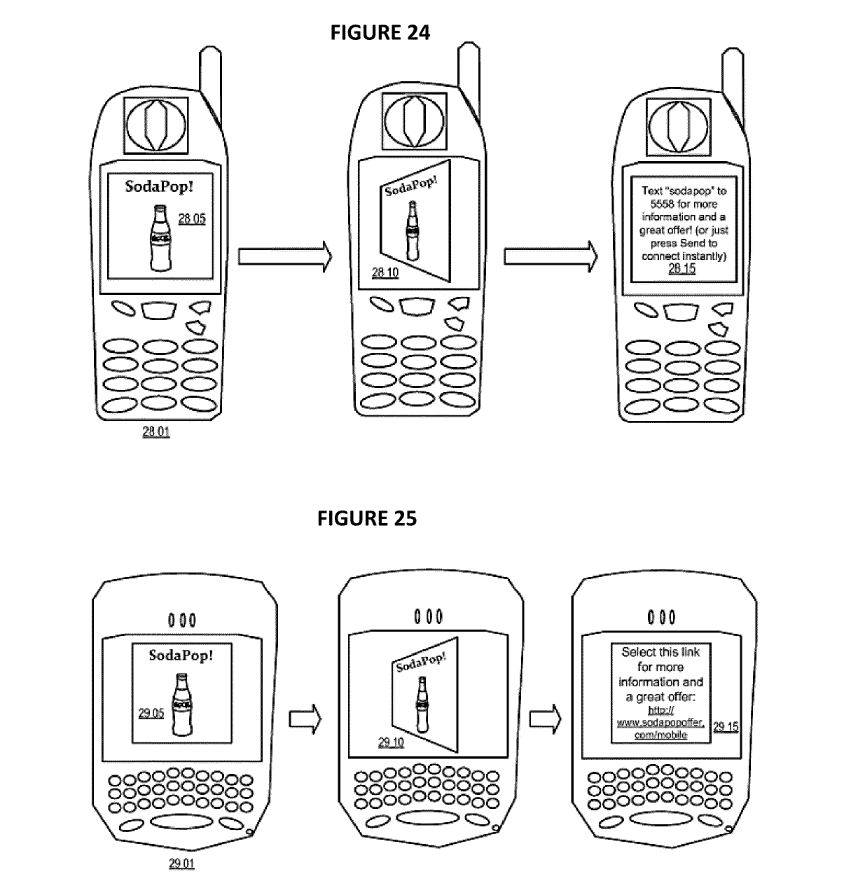

FIG. 24 shows an implementation of a user interface manifesting GCSI/CTIS functionality on a mobile phone 2801 in one embodiment of GCSI/CTIS operation. The user may register interest in a particular artifact by initiating a data capture of the artifact, in this case a bottle of SodaPop 2805. A first visual token comprising an image, advertisement, logo, and/or the like of the artifact 2805 is displayed on a mobile phone display screen. The first visual token may be animated 2810, such as in response to a user interaction (e.g., pressing a button on the mobile telephone, clicking on the first visual token with a pointer widget, and/or the like). In an alternative implementation, the first visual token may be automatically animated and/or animate without the need for any user interaction. In the illustrated implementation, the animated first visual token flips to reveal a second visual token comprising a message and an SMS text message prompt on a proximate side 2815. In one implementation, the user may manually key in the text message and/or destination address to receive the associated content. In another implementation, the GCSI/CTIS interface may supply a selectable link that, when selected, will automatically generate an SMS text message to retrieve the associated content. In still another implementation, such as the example illustrated at 2815, the user may be allowed to automatically generate and/or send the SMS text message from the second visual token by pressing a “Send” button on the mobile phone, clicking and/or otherwise interacting with the second visual token, and/or the like.

In one implementation, a user may select an artifact, such as a SodaPop, capture data from the artifact, then receive a coupon and/or coupon code in response to an interaction with the second visual token, sending of an SMS or MMS text and/or other message in response to the second visual token, and/or the like. For example, in one implementation, a user may receive a numerical coupon code in response to a sent SMS text message, wherein the numerical coupon code may be presented to a retailer, entered into a website, and/or the like to receive discounts, free items, special offers, and/or the like. In another implementation, the user may receive a scannable code, such as a QR code, matrix code, and/or the like in response to a sent SMS or MMS text message or other message type, wherein the scannable code may be scanned by a retailer in order for the user to receive the associated benefits, discounts, and/or the like. For example, the scannable code may appear on a user's mobile phone display screen and may be scannable therefrom to provide the user with the benefits associated thereto. In another implementation, the user may receive an e-mail message in response to interaction with a graphical code-serving interface, the message containing requested content and/or links thereto, scannable codes, coupon codes, and/or the like.

In another implementation, a first visual token may comprise a “poster” image corresponding to a full-length movie, movie preview, video clip, television show, and/or the like. The second visual token revealed on a proximate side of the first visual token may then enable a user to retrieve the full video content associated with the poster image. For example, a user may scroll through a series of poster images corresponding to a series of full-length movies. When the user finds a movie he or she desires to retrieve, watch, download, and/or the like, he or she may select the corresponding poster image, which may then be animated to reveal a second visual token, such as an SMS instruction, message, delivery address, phone number, and/or the like, whereby the user may interact with a GCSI/CTIS system and/or affiliated entity to retrieve the desired movie content.

In one implementation, a series of first visual tokens may be displayed as scrollable thumbnails, within a cinematic presentation, as an immersive slideshow, and/or the like.

FIG. 25 shows an implementation of a user interface manifesting GCSI/CTIS functionality on a portable communication device in one embodiment of GCSI/CTIS operation. The portable communication device 2901 shown in the illustrated implementation may represent a Blackberry, iPhone, PDA, and/or the like. A first visual token 2905 is animated 2910 to reveal a message and a selectable hyperlink on a proximate side 2915, in this case a URL connecting to content, information, offers, coupons, and/or the like. In one implementation, a user may be permitted to directly select the hyperlink from the displayed image using interface elements of the device in order to retrieve content, view a webpage, interact with a GCSI/CTIS and/or affiliated system, and/or the like.

A variety of operational models may be employed to provide code-serving interface capabilities to users and content providers alike in accordance with the embodiments and/or implementations described herein. In one implementation, a central GCSI/CTIS server may enable content providers to supply first and/or second visual tokens, associated SMS and/or MMS codes, and/or any other information necessary to connect users to supplied content. The central GCSI/CTIS server may then outfit the supplied tokens and/or other information with HTML markup information allowing the code-serving interface to be embedded in any webpage or other display media. In one implementation, the HTML markup information may further include a link to one or more downloadable applets that may be required to enable a user to view and/or interact with the code-serving interface. Having provided the data corresponding to a first and/or second visual token, SMS and/or MMS code, and/or other information, a content provider may be provided with an embeddable link, URL, and/or the like that may be cut and pasted into a web page HTML to embed the code-serving interface therein.

In another implementation, a content provider may submit just a first visual token and response content and/or a means of addressing said content, and a GCSI/CTIS server may generate a corresponding code-serving interface, a dial-in code and/or SMS and/or MMS address, hyperlink, and/or the like to allow users to interact with the first visual token to receive the response content. In one implementation, the generated code-serving interface may include HTML markup information enabling it to be embeddable on any webpage. A fee may be charged to the content provider, such as on a pay-per-click basis, for user interactions with the generated code-serving interface.

In still another implementation, a webpage or other display area may include a generic placeholder for code-serving interfaces that may be filled by code-serving interfaces and/or associated content supplied from one or more advertisement servers and/or GCSI/CTIS servers. The supplied code-serving interfaces may be selected based on webpage content, contextual cues, and/or the like and/or based on the goals of content providers and/or code-serving interface creators. For example, an advertiser may wish to place a particular code-serving interface associated with a new action movie on any webpage having a generic placeholder that mentions extreme sports. A fee may be charged to an advertiser for such targeted and/or contextual placement, such as on a bid-per-keyword basis. Fees may also be charged on a pay-per-click basis (i.e., levying a charge whenever a user clicks a code-serving interface to reveal the code, communication address, and/or the like on a proximate side).

### GCSI/CTIS Media Acquisition Example

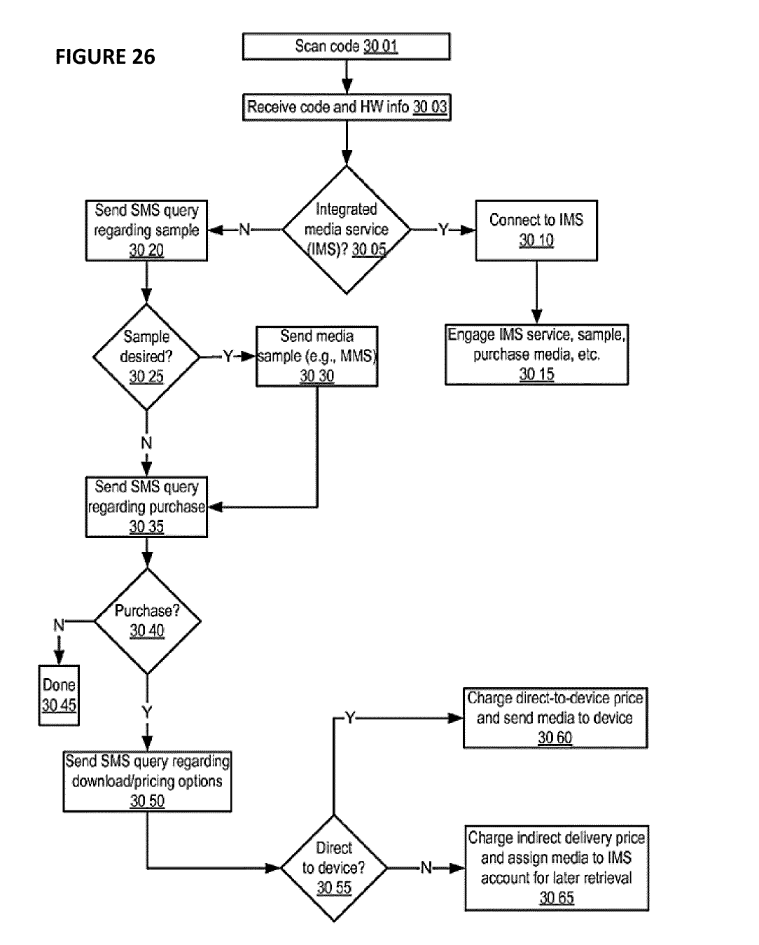

In some embodiments, the GCSI/CTIS may be configured to supply media content, music, images, video, and/or the like to users based on the scanning of artifacts as described above. Acquisition of full media content may, in some implementations, be preceded by acquisition of media samples that may be reviewed by an acquiring user to determine whether or not to proceed with acquisition of the full content. For example, a billboard may display the Billboard Top 20 songs with a separate code for each song on the list. Consumers, in this example, may scan codes corresponding to each song in the list for which they have interest using a mobile scanning device and receive a sample of each song. In one implementation, a sampling user may further be provided with an opportunity to purchase and/or otherwise acquire the full media content once the sample has been received and/or reviewed. In one implementation, media may be acquired by a user via MMS messaging, while in another implementation, media may be acquired by means of an integrated media service (IMS). The IMS may, in one implementation, comprise an on-demand media service wherein users may maintain accounts, sample and/or purchase media, download and/or upload media, and/or the like. An example of an IMS is Apple's iTunes Store. FIG. 26 shows an implementation of logic flow for media sampling and full media acquisition in one embodiment of GCSI/CTIS operation. A media artifact may be scanned by a user 3001, such as via a mobile device. The scanned media artifact information, and optionally, hardware information identifying the device, the user, and/or the like may then be received by GCSI/CTIS from the mobile device, such as via a communications network. The GCSI/CTIS may then make a determination, such as may be based on the hardware information, user information, a user profile, and/or the like, as to whether the mobile device is configured with an IMS 3005. If the mobile device is configured with an IMS, the GCSI/CTIS may issue an instruction to the mobile device to connect to the IMS 3010, allowing the user to engage IMS functionality such as the sampling, purchasing, downloading, viewing/playing, and/or the like of media files 3015.

If the user's mobile device is not configured with an IMS, the GCSI/CTIS may send a message to the device, such as an SMS text message 3020, to determine if the user desires to receive a sample of the requested media 3025. In one implementation, the GCSI/CTIS may first interact with a media service to determine if a sample is available before offering the sample to the user. If a sample is desired, the GCSI/CTIS may send a media sample to the user's mobile device, such as in the form of an MMS message. The sample may, in various implementations, comprise a clipped and/or low-quality version of an audio file, image file, video file, publication, and/or the like. In one implementation, the GCSI/CTIS may first acquire the sample from a music service in order to provide it to the user's mobile device. In an alternative implementation, the GCSI/CTIS may itself generate a sample from an original copy of a media file, such as may be acquired from a media service.

The GCSI/CTIS may then generate and send a query, such as via SMS text message 3035, to determine if the user would like to purchase the media associated with the scanned code 3040. If not, the GCSI/CTIS may exit the routine associated with the acquisition of the current media file, present alternative and/or related media files for user consideration, and/or the like 3045. If, on the other hand, the user indicates a desire to purchase the media file in question, the GCSI/CTIS may query the user, such as via an SMS text message, as to which of a selection of pricing and/or download options the user would like to pursue 3050. For example, in various implementations, the user may be provided with options as to the quality and/or format of media files acquired, the method of acquisition, accessibility and/or rental options, and/or the like. In the illustrated implementation, the user may be presented with an option as to the method of media acquisition. Specifically, a determination may be made as to whether or not the media is to be acquired directly by the user's mobile device 3055. In the illustrated implementation, the determination is based on a user preference, however in alternative implementations, the determination may be made, in whole or in part, based on a variety of other factors, such as detected capabilities of the user's mobile device, available network bandwidth, pre-set profile settings, and/or the like. If the user selects for the media to be directly provided to his or her mobile device, then a corresponding fee may be charged and the media may be streamed, downloaded, and/or the like directly to the user's mobile device 3060. Alternatively, if the user does not desire to acquire the media directly to his or her mobile device, then the GCSI/CTIS may charge a price corresponding to an indirect delivery mode and conduct the media file to an intermediary storage facility for later retrieval 3065. For example, the GCSI/CTIS may instruct a media service to allocate the media file to a user account for later retrieval by the user. In another example, the GCSI/CTIS may acquire the media file and/or email the file to a user email account for later retrieval. When the user is ready, he or she may obtain the media file from the intermediary storage facility, transfer the file to a mobile device, and/or the like.

The charging of a fee for acquired media may proceed in a variety of different manners within various embodiments of the GCSI/CTIS. For example, in one implementation, a user may be directly requested to enter payment information (e.g., credit card number, checking account number, etc.) at the time of purchase. The entered information may be verified before the media is made available to the user and/or the user's mobile device. In another implementation, a user may enter payment information into a user profile and have a corresponding account automatically charged when the user directs the GCSI/CTIS to acquire media.

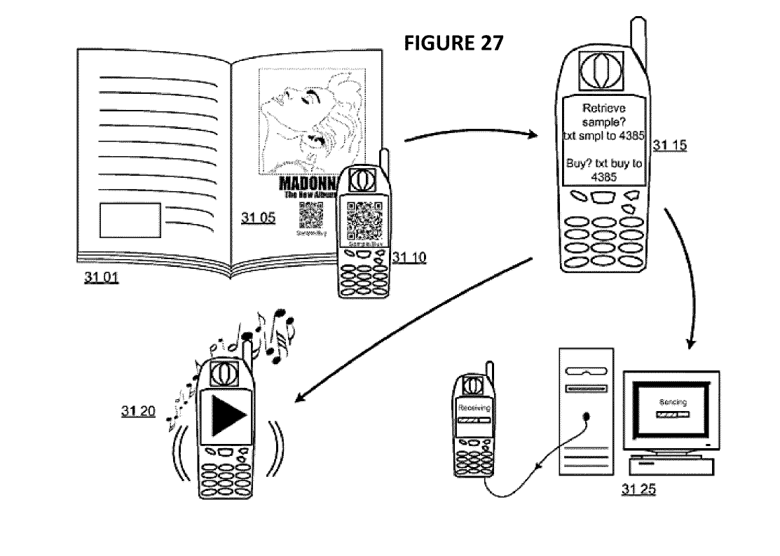

FIG. 27 shows an illustration of media acquisition in one embodiment of GCSI/CTIS operation. In the illustrated implementation, a printed publication 3101 displays an advertisement for a new release by a recording artist 3105, the advertisement artifact is scanned and artifact data captured to facilitate acquisition of media associated with the new release by a user. In an alternative implementation, an animated user interface may present a scannable code or other artifact on a proximate side of a first image, such as on a video billboard, website, television program, and/or the like. The media may, for example, comprise an entire album, a single, a ringtone, a video, an image, and/or the like. In one implementation, the media provided may depend on the scanned code in conjunction with a user profile containing user preferences, a history of user behavior and/or prior scanned artifacts, and/or the like. The user may engage the media content by scanning the artifact with his or her mobile device 3110, after which the GCSI/CTIS may query the user, such as via an SMS text message, as to whether or not he or she wishes to sample and/or purchase the requested media 3115. The user may respond, in one implementation, by sending a reply text message to be relayed to the GCSI/CTIS. In one implementation, the GCSI/CTIS may subsequently provide, stream, upload, and/or the like the requested media directly to the user's mobile device for storage and/or playback 3120. In another implementation, the GCSI/CTIS may provide the requested media to an intermediary storage facility, such as a user's media service account, an email server, an ftp server, and/or the like. The user may then subsequently procure the media from the intermediary storage facility, transfer the media to a mobile device, and/or the like 3125 at a later time.

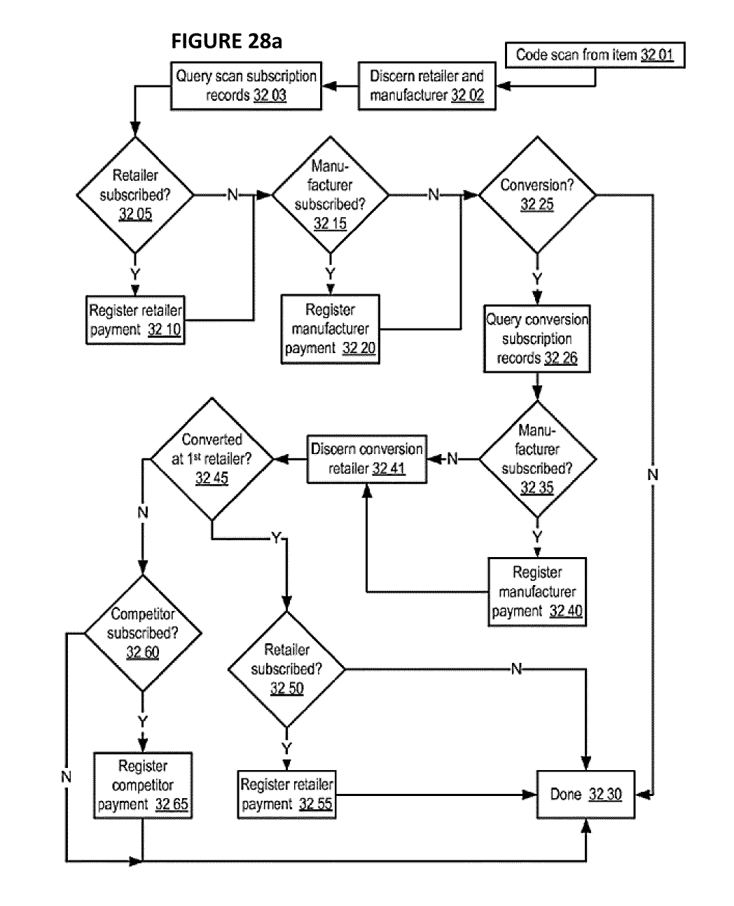

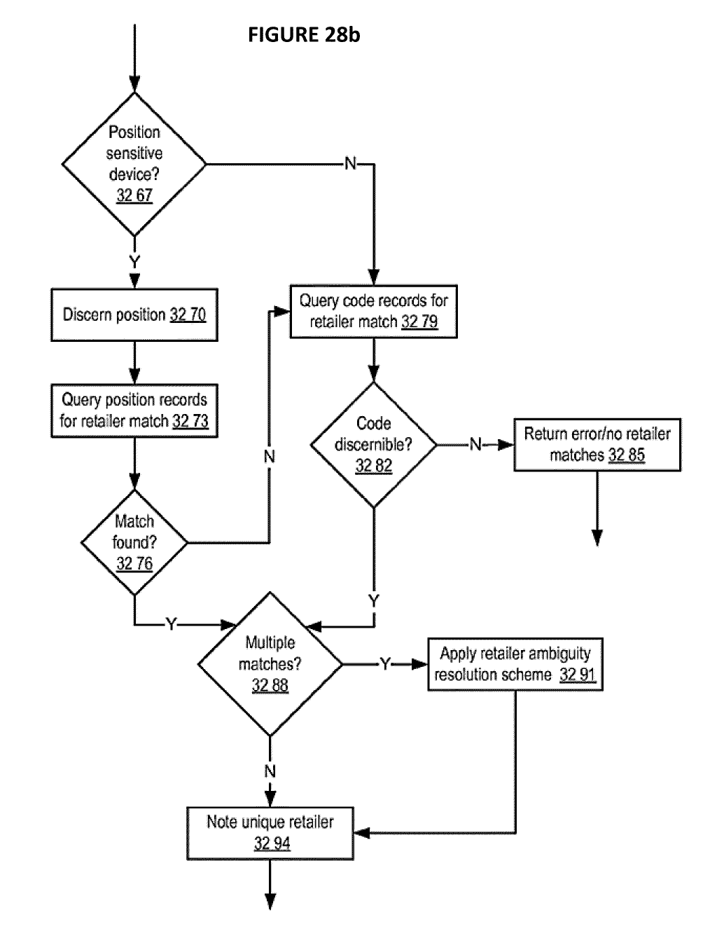

FIGS. 28 a-b show an implementation of logic flow for an artifact scan monetization in one embodiment of GCSI/CTIS operation. In FIG. 28 a, an artifact, which may be a barcode or the cover of a product is scanned at 3201. In the illustrated implementation, the artifact may be the physical item that is subject to purchase and may be found in a retail establishment. For example, the cover of a compact disc (CD) in a music store may be the artifact scanned by the user and provide a sample of the music stored on the CD, deliver a ringtone to the user's mobile scanning device, provide artist information, images, concert dates, a coupon, and/or the like. In another implementation, the item for purchase may not be physical but rather may be provided online, such as on a web site, and an associated code may be provided on the page on which the item is offered for purchase. Once the artifact is scanned 3201, a determination may be made as to whether the retailer providing the item is subscribed to a GCSI/CTIS service 3205. In one implementation, the retailer may be discerned based on a geographic position provided to the GCSI/CTIS by a code message sent from the user's mobile device that may, for example, be compared to records of retailer locations. The geographic position may be determined, for example, by an on-board GPS unit on the user's mobile device or based on geographic information contained in the scanned code. Subscription to the service may, for example, entail licensing to embellish items with GCSI/CTIS affiliated codes in exchange for a fee, such as a one-time or periodic fee and/or a per-scan fee, such as illustrated in the implementation shown in FIG. 28a. If the retailer is determined at 3205 to be a subscriber, then the GCSI/CTIS may register a retailer payment 3210. For example, in one implementation, registering payment may comprise noting the fee in a fee record. In an alternative implementation, the GCSI/CTIS may automatically deduct the fee from a pre-designated account. A determination may also be made as to whether the manufacturer, publisher, distributor, and/or the like of the item in question is a subscriber 3215. For example, for the case of the CD discussed above, the “manufacturer” may comprise a record label. If the manufacturer is determined to be a subscriber, then a manufacturer payment is registered at 3220.

Discernment of retailer, competitor, and/or manufacturer identities may be accomplished by a variety of different schemes in various implementations and/or embodiments of GCSI/CTIS operation. For example, brand names are uniquely associated with a particular manufacturer, retailer, and/or the like, such that a scan message corresponding to any brand name artifact provides a unique identifier that may be associated by a GCSI/CTIS system with the particular manufacturer, retailer, and/or the like. In another implementation, retailer names associated with a given scanned artifact may be discerned based on a recognition of the brand name and/or the geoposition of the mobile scanning device at the time of artifact scanning FIG. 28 b provides an illustration of an implementation of logic flow for discerning retailers in one embodiment of GCSI/CTIS operation. A determination is made at 3267 as to whether the mobile scanning device used to scan an artifact is position sensitive. Position sensitivity of a mobile device may be facilitated, for example, by an on-board GPS unit, mobile device and/or cellular tower triangulation, trilateration, multilateration, and/or the like. If the device includes one or more position sensitive facilities, the GCSI/CTIS may discern the position of the mobile device 3270. Position discernment by the mobile device and/or the GCSI/CTIS may include drawing raw geographic position data from one of the facilities described above using, for example, mobile device software development kit (SDK) tools, an example of which are those associated with the iPhone SDK toolkit. The GCSI/CTIS system may then query position records based on the position discerned at 3270 to seek retailers matching that position 3273. A determination is made at 3276 as to whether any matching retailers are found. If no retailers match the discerned mobile device position, or if the mobile device lacks position sensitivity at 3267, the GCSI/CTIS system may query code records based on the scanned code received from the mobile device to seek retailers matching the scanned code 3279. A determination is made at 3282 if any retailers are code discernible and, if not, then the GCSI/CTIS may return an error message and/or record that no matching retailer was found 3285. If any matches are found either by position or code discernment, then a determination may be made as to whether there exist multiple retailer matches 3288. If not, then the unique matching retailer may be recorded, provided to facilitate subsequent code scan monetization, and/or the like 3294. If multiple retailer matches exist, the GCSI/CTIS system may apply one or more retailer ambiguity resolution schemes 3291 in order to narrow down the results to a unique retailer match. A wide variety of ambiguity resolution schemes may be employed within different implementations and/or embodiments of GCSI/CTIS operation. For example, in one implementation, a GCSI/CTIS system may consult a user profile associated with the user who's mobile device issued the code scan to determine whether the user's code scan history indicates a preference for a particular retailer, retailer type, and/or the like which may assist in further discerning the unique retailer associated with the current code scan. In another implementation, the GCSI/CTIS system may provide a plurality of possible retailer matches in a message (e.g., an SMS message) to a user's mobile device and request feedback as to which retailer is the correct one in whose establishment the code was scanned.

A determination may then be made as to whether a conversion has taken place whereby the user has actually purchased the item associated with the scanned artifact. In one implementation, the GCSI/CTIS may monitor activity on a credit card associated with a user account once that user has registered an artifact scan or completed a purchase activity. A subsequent purchase using the associated credit card may then register a conversion with the GCSI/CTIS. If no conversion is detected, such as within a pre-designated period of time, then the artifact scan monetization is complete for the particular code scan 3230. If, on the other hand, a conversion is registered, a determination may be made as to whether the manufacturer is subscribed to pay further fees upon item conversion 3235. If so, then the additional manufacturer payment for conversion is registered at 3240.

A determination may be made as to whether the conversion, i.e., the purchase of the artifact-associated item, was made at the retailer at which the artifact was scanned 3245. If so, then a determination may be made as to whether the retailer is subscribed to pay an additional fee associated with item conversion 3250. If so, that payment is registered at 3255. If the conversion occurs at a competitor retailer different than the original retailer at which the item-associated code was scanned (e.g., another brick-and-mortar retailer, another website, etc.), a determination may be made as to whether the competitor retailer is subscribed to pay a fee for item conversion 3260. If so, then the competitor payment may be registered at 3265. In one implementation, a competitor may be permitted to supply a message (e.g., an SMS text message, and/or the like) to a user's mobile device when the user scans artifacts at particular retail locations in order to entice the user to purchase the item from the competitor instead of at the particular retail location in which the artifact was scanned. The competitor message may, for example, include a coupon and/or other discount on the sale price of the artifact-associated item. In one implementation, the competitor may be charged a separate fee for being allowed to supply such messages, such as a per-message fee, a one-time or periodic fee, and/or the like.

In some implementations, fees charged to manufacturers, retailers, and/or competitors may be substantially the same. In alternative implementations, different fees may be charged to manufacturers, retailers, and/or competitors.

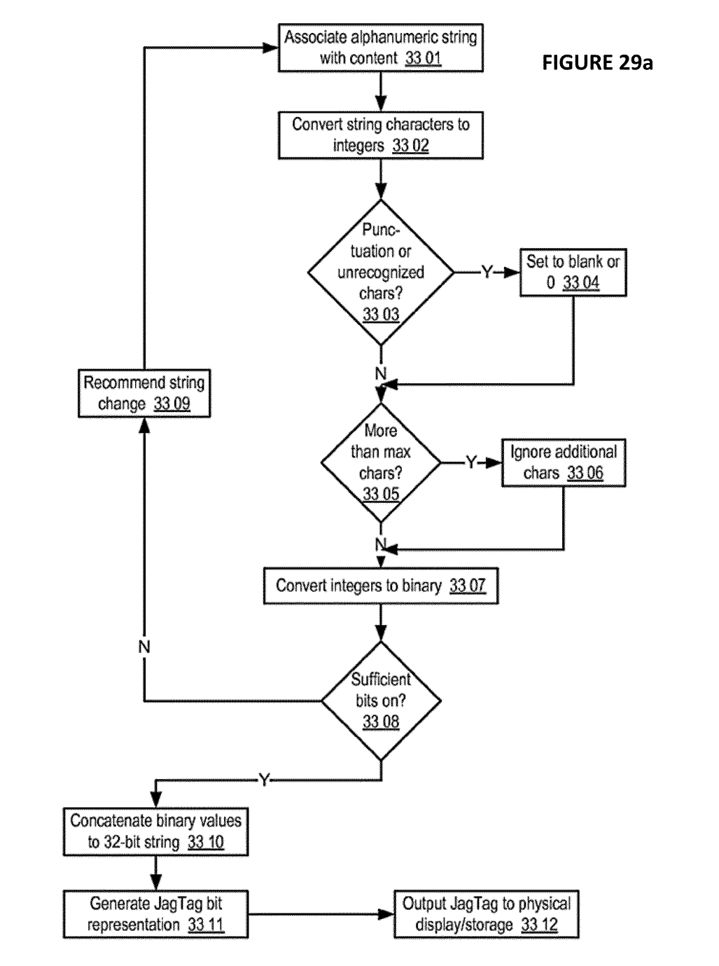

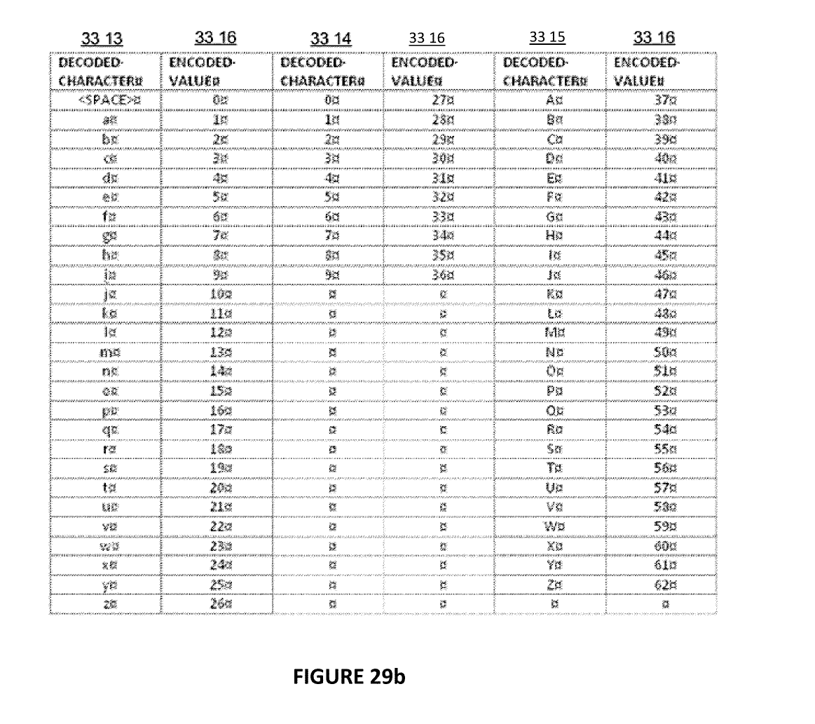

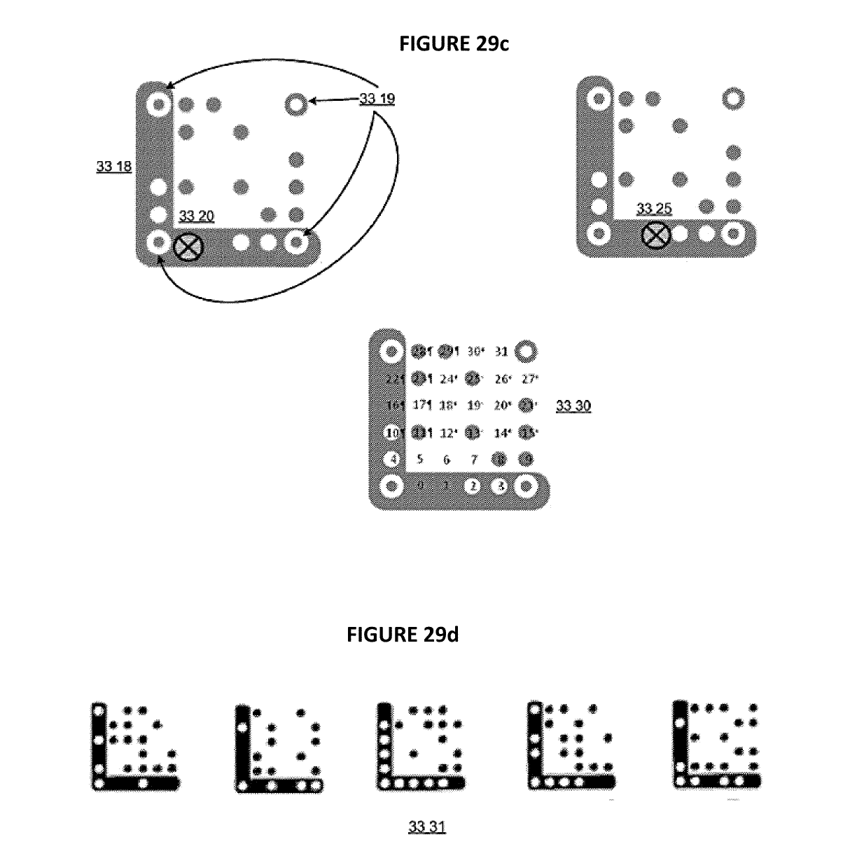

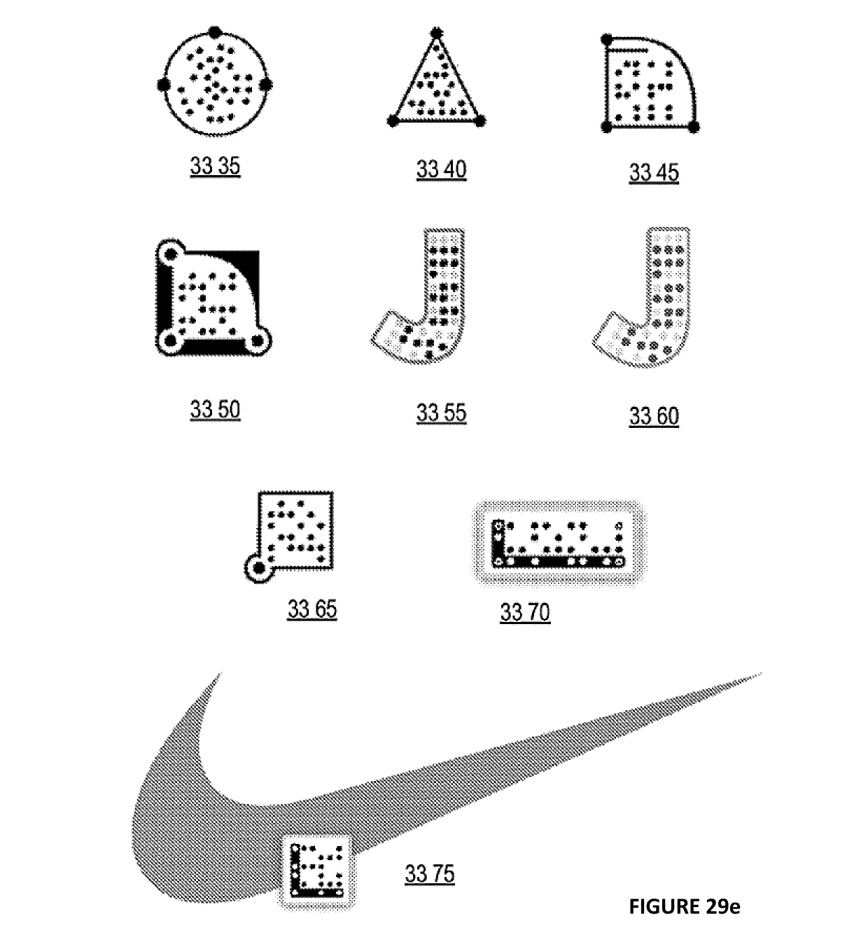

One particular type of artifact that may be useful in the present invention are implementations of JagTag encoding and JagTag codes. Jag Tag encoding and JagTag codes are discussed in greater detail in the '527 Published Application which is hereby incorporated by reference. In addition to the conventional application of JagTag's as optical barcodes, a JagTag may be rendered as a 3D barcode and employed either as an optical barcode or a tactile code. FIGS. 29 a-e show aspects of implementations of JagTag encoding and codes in some embodiments of GCSI/CTIS operation. FIG. 29 a shows an implementation of logic flow for JagTag encoding in one embodiment of GCSI/CTIS operation. An alphanumeric string may be associated with content to which a JagTag code is ultimately to be associated 3301. In one implementation, a five character string is employed. Each character of the alphanumeric string may then be converted into a corresponding integer, such as may be based on a correspondence table 3302. FIG. 29 b shows an implementation of such a corresponding table relating decoded characters, including lowercase letters 3313, numbers 3314, and uppercase letters 3315, to encoded values 3316 comprising integers between 0 and 62. To convert the alphanumeric string into a JagTag code, each character in the string is converted into a corresponding integer between 0 and 62 using the table in FIG. 29 b. A determination may then be made as to whether any of the characters comprise punctuation marks or other unrecognizable or unconvertible characters 3303. If so, those characters are set to blanks or zeros in the resulting string of integers 3304. A determination may also be made as to whether the number of characters in the alphanumeric string exceeds a pre-designated maximum number 3305 (e.g., 5 characters). If so, additional characters are ignored 3306.

Each resulting integer may then be converted to a corresponding binary value 3307, and a determination may be made as to whether there are a sufficient number of “on” bits (i.e., bits equal to 1) 3308. For example, the GCSI/CTIS may require the existence of at least some minimum number (e.g., 9) of on bits. If not, then the system may return an error message and/or recommend that the user try a different initial alphanumeric string 3309. Otherwise, the GCSI/CTIS system may concatenate the string of binary numbers to yield a single 32 bit long bitset array 3310. The system may then generate a JagTag bit representation 3311, as described below, and output the resulting JagTag to a physical display and/or storage (e.g., storing an image formatted JagTag in a database, printing the JagTag, displaying the JagTag on a display screen, and/or the like) 3312.

The first bit of the bitset array may be considered a most-significant bit and the last bit of the bitset array may be considered a least-significant bit. Once complete, the 32 bit binary bitset array may be converted into a JagTag code representation. FIG. 29 c further illustrates JagTag encoding in one implementation. The JagTag may include an L-shaped component 3318 that may, in one implementation, promote orientational and/or size discrimination of the JagTag, such as by a scanning or analyzing device. The JagTag may further include four circular elements 3319 that may also serve to promote orientational and/or size discrimination. The most significant bit of the bitset array may be encoded as a circle at the position indicated by the crossed circle at 3320, with a white circle (owing to the dark background of the L-shaped component 3318) indicating a 1 and no circle indicating a 0. The next most significant bit of the bitset array, then, may be encoded as a circle at the position indicated by the crossed circle at 3325. The numbering scheme indicated at 3330 shows how the circles (or lack of circles) at positions numbered from 0 to 31 correspond to the bits in the 32-bit bitset array, with 0 the most significant bit and 31 the least significant bit. If the bit falls on the L-shaped component 3318, a white circle is drawn for a bit value of 1, and otherwise a dark circle is drawn for a bit value of 1.

In one implementation, a shell script may be configured to accept an alphanumeric string comprising characters to be encoded and to return a JagTag in an image format, such as a PNG, JPG, GIF, BMP, and/or the like file format. In one implementation, the shell script may be further configured to receive a color specification (e.g., an HTML-style RGB triplet).

Configuring a JagTag for optimal recognition may be accomplished in a variety of different ways within different implementations. For example, a color for the JagTag code may be selected to as to have high contrast with the background color. A high number of “on” bits (i.e., bits equal to 1) may also improve code recognition, as discussed above. Accordingly, in one implementation, resulting JagTag codes having fewer than a minimum number of on bits may be rejected. Other measures that may be taken in various implementations to improve JagTag recognition may include maximizing code dimensions, ensuring that the code is surrounded by a substantial margin (e.g., at least 25% of the code's width and height), and ensuring fidelity of the code by eliminating any obscuring interferences. JagTag codes may be configured for a wide variety of physical manifestations, including printing on magazine pages, billboards, newspapers, and/or the like, displaying on video display screens, television broadcasts, websites, and/or the like. JagTags may also be configured into different shapes or display configurations in various implementations.

The color, spatial, orientational and character recognition principals of JagTags may further be employed to non-barcode recognition of artifacts. Specifically, the recognition principals underlying JagTag encoding tie the color, spatial, orientational and characters of JagTags to specific data points. Similarly, non-barcode artifact recognition, for example, of product configurations, may be employ similar principals as those employed with JagTags. For example, a given product configuration will have specific three dimensional geometries, colors, characters, graphical elements and the like. Each of these specific product configuration characteristics, therefore, provides data points upon which a product configuration may be digitally expressed and stored in a dataset. For example, a bottle of COCA-COLA has a unique shape, the color of the bottle and the color of the cola contents have discernible colors, the color and configuration of the brand name script on the bottle is uniquely discernible, as is the dimensional size of the bottle. Data points may be ascribed to each of these features, in the same manner as with JagTags, and the data points maintained within the CTIS Database for access when a user may capture a bottle of COCA-COLA.

FIG. 29 d shows one non-limiting embodiment of data loss resilient codes 3331, with characteristics that include: reducing errors based on “bleeding” of encoded data points by using circles/dots rather than squares that touch each other (this combats fuzziness of image as well as reduced light conditions); using a stronger identifier to discover processing directionality (rotation, skew, slant)—this is the black line with white dots shown in the figure; including data points within the identifier in order to maximize encoded data as well as allow for reduction in size of code; using equidistant lengths on identifier to process for skew and slant; using constant data points within the directional identifier to process for skew and slant—this may be top left, bottom right and bottom left white dots (not indicated in FIG. 29 d); reducing the amount of data encoded in the code—most likely 5-8 characters—in order to allow for size reduction of the code; developing code characteristics so partial decoding allows for matching code to correct data on the server—for example, if only 70% of the characters from a code are discernible, the GCSI/CTIS can use server logic to extrapolate what the code is as well as the campaign/client it's associated with, i.e., information about the exact publication the code is in may be lost, but the GCSI/CTIS system can figure out the campaign and return an appropriate message; with regard to partial decode matching, server side and database logic focuses both on creating codes for clients and campaigns that are unique sets in order to enable partial decode matching as well as providing a set of rules around time, mobile number, and likelihood in order to determine the best potential match for partial decodes.

In the embodiment of the basic codes 3331 shown in FIG. 29 d, design wrapped around the code does not impact the effectiveness of the decoding. High tone color differentials are allowed, so rather than black, dark blue or red could be used. The white dots in the identifiers are less likely to allow for color changes although a very light yellow or gray may be allowed.

In a further embodiment, the dots most likely to be lost in an image may be assessed and the least useful information encoded appropriately based on that assessment. An interesting opportunity for this code is that it allows for some logos to potentially replace the dots. For example, an Alltel logo can be used nearly as well as the dots, or a Nike logo is decodable with some server side code modifications.

The codes have an additional benefit in that they are in and of themselves, aesthetically pleasing, and as such offer significant advantages over previous codes. The ability in one embodiment, to vary the colors of the code, allows it to better integrate and look better in marketing contexts.

FIG. 29 e shows some implementations of alternative JagTag display configurations, including circular 3335, triangular 3340, modified squares (3345, 3350, 3365), rectangular 3370, letter shaped (J shapes shown at 3355 and 3360), and/or the like. JagTags may also be displayed in proximity to and/or integrated with other codes, logos, insignias, and/or the like, such as shown at 3375.

### GCSI/CTIS Controller

FIG. 30 of the present disclosure illustrates inventive aspects of a GCSI/CTIS controller 3401 in a block diagram. In this embodiment, the GCSI/CTIS controller 3401 may serve to aggregate, process, store, search, serve, identify, instruct, generate, match, and/or update Scan Messages, Reply Messages, Ads, user profiles, and/or other related data.

Typically, users, which may be people and/or other systems, engage information technology systems (e.g., commonly computers) to facilitate information processing. In turn, computers employ processors to process information; such processors are often referred to as central processing units (CPUs). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the GCSI/CTIS controller 3401 may be connected to and/or communicate with entities such as, but not limited to: one or more users from user input devices 3411; peripheral devices 3412; a cryptographic processor device 3428; and/or a communications network 3413.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The GCSI/CTIS controller 3401 may be based on common computer systems that may comprise, but are not limited to, components such as: a computer systemization 3402 connected to memory 3429.

A method for shopping using a computing device and a data capture system has been described herein, generally comprising the steps of: targeting with the data capture system a target of interest to a shopper; capturing data from the target of interest, the data being representative of at least one sensory input of visual, auditory, haptics, olfactory or gustatory; communicating at least some of the captured data to a data repository; comparing the communicated data with information stored in the data repository; and returning at least one response from the data repository to the computing device based upon the communicated data. The response further comprises information that prompts the shopper to take an action, prompts the shopper for a disposition on information provided, or provides information to the shopper relevant to either the target of interest or alternatives to the target of interest. The method may further comprise the step of communicating at least one shopper disposition on the prompt to the data repository. The method may further comprise the step of taking at least one action at the data repository based on the at least one shopper disposition on the prompt. The target of interest is an advertisement, the captured data is representative of the advertiser's brand, and the response comprises information such as other products of the advertiser that the shopper may be interested in, information about the particular product advertised, information about alternative products or services from competitive sources other than the advertiser, or information presenting the shopper with the advertiser's full internet affiliate site.

The response may comprise information representative of at least one of: links to brand names; products by brand name; product images; URLs for branded products; point of purchase URLs; customer reviews of branded products; pricing; product descriptions; links to product classifications; product configurations; brand names; styles; color combinations; customer reviews of products; links to music sources; classifications based upon artist; music genre; production label; music titles; album titles; customer reviews of music; music descriptions; artist descriptions; links to sources of scents; classifications based upon scent characterization; perfume product listings; product images; product information and pricing; links to sources of texture characterization; classifications of product types based upon texture characterization; links to sources of food taste characterization; classifications of food types; links to food sources; food descriptions. The method may further comprise the step of enhancing the at least one response based on ambient conditions determined either by the computing device or the data repository. The target of interest is an artifact capable of capture, comprising at least one of a barcode, a 2D code, a matrix code, a data matrix, a QR code, or other such symbology. The visual sensory input may comprise at least one of visual pattern recognition, environmental or contextual recognition, text recognition, color recognition, motion detection, motion capture, motion recognition, or hand or body gestures.

The auditory sensory input may comprise at least one of music, sound patterns, or natural or artificially-generated sounds. The olfactory sensory input may comprises at least one of data representing scents from foods, perfumes or colognes, environmental pollutants, ambient atmospheric scents, or gases emitted in agricultural or industrial production. The tactile sensory input may comprise at least one of data representing textiles or material surface characterization, such as that during planarizing or patterning processes. The gustatory sensory input may comprises at least one of data pertaining to relative sweetness, tartness, bitterness, spiciness, acidity, basicity or other qualities pertaining to the taste of food-stuffs.

The captured data may be representative of at least one of voice, music, brand images, brand texts, product images, textile patterns, hand or body gestures, or environmental patterns such as building, signage or intersection landmarks. The response returned to the shopper may be at least one of multi-modal and multi-variant. The target of interest may comprise a pure image, an action taken by the shopper (such as the selection of an internet link), an RFID tag, software inputs, and/or the like. The communicated data may further comprise a user ID, a hardware ID, a geocode, a timestamp, a subject code, a source code, a content code, and/or the like. The captured data may be communicated to the data repository by SMS protocol, MMS protocol, instant messaging, web browser based messaging, email, Enhanced Messaging System, TCP/IP, WAP, and/or the like. The response returned from the data repository to the shopper's computing device may be communicated by SMS protocol, MMS protocol, instant messaging, web browser based messaging, email, Enhanced Messaging System, TCP/IP, WAP, and/or the like. The data repository is a component of a Code Triggered Information Server (CTIS). The target of interest may comprise at least one of products, activities, services, print, visual, electronic or audible media, barcodes, brand names, product configurations including packaging or container configurations, shapes or color combinations for products, video, body movements or gestures, olfactory scents, haptic or tactile stimuli, sound stimuli, and gustatory or taste stimuli.

A method of structuring and interfacing with a database wherein data captured by a digital device is transmitted as a structured query to the database which returns a response to the digital device, may comprise the steps of: capturing data corresponding to an artifact of interest to a user, wherein the digital device formulates a first communication with the data repository; processing the captured data and the first communication containing at least some of the captured data with a data repository; and receiving a response from the data repository, the response containing at least some data corresponding to or relevant to the artifact of interest to the user. The method may further comprise the step of communicating the first communication to the data repository. The response may further comprises information that prompts the user to take an action, prompts the user for a disposition on information provided, or provides information to the user relevant to either the artifact of interest or alternatives to the artifact of interest. The method may further comprise the step of communicating at least one user disposition on the prompt to the data repository. The method may further comprise the step of taking at least one action at the data repository based on the at least one user disposition on the prompt.

The artifact of interest may be an advertisement, the captured data is representative of the advertiser's brand, and the response comprises information such as other products of the advertiser that the user may be interested in, information about the particular product advertised, information about alternative products or services from competitive sources other than the advertiser, or information presenting the user with the advertiser's full internet affiliate site.

The response may comprise information representative of at least one of: links to brand names; products by brand name; product images; URLs for branded products; point of purchase URLs; customer reviews of branded products; pricing; product descriptions; links to product classifications; product configurations; brand names; styles; color combinations; customer reviews of products; links to music sources; classifications based upon artist; music genre; production label; music titles; album titles; customer reviews of music; music descriptions; artist descriptions; links to sources of scents; classifications based upon scent characterization; perfume product listings; product images; product information and pricing; links to sources of texture characterization; classifications of product types based upon texture characterization; links to sources of food taste characterization; classifications of food types; links to food sources; food descriptions.

The method may further comprise the step of enhancing the at least one response based on ambient conditions determined either by the digital device or the data repository. The artifact of interest comprises at least one of a barcode, a 2D code, a matrix code, a data matrix, a QR code, or other such symbology.

The artifact of interest may comprise a visual sensory input of at least one of visual pattern recognition, environmental or contextual recognition, text recognition, color recognition, motion detection, motion capture, motion recognition, or hand or body gestures. The artifact of interest may comprise an auditory sensory input of at least one of music, sound patterns, or natural or artificially-generated sounds. The artifact of interest may comprise an olfactory sensory input of at least one of data representing scents from foods, perfumes or colognes, environmental pollutants, ambient atmospheric scents, or gases emitted in agricultural or industrial production. The artifact of interest may comprise a tactile sensory input of at least one of data representing textiles; or material surface characterization, such as that during planarizing or patterning processes. The artifact of interest may comprise a gustatory sensory input of at least one of data pertaining to relative sweetness, tartness, bitterness, spiciness, acidity, basicity or other qualities pertaining to the taste of food-stuffs.

The captured data may be representative of at least one of voice, music, brand images, brand texts, product images, textile patterns, hand or body gestures, or environmental patterns such as building, signage or intersection landmarks. The response returned to the user may be at least one of multi-modal and multi-variant. The artifact of interest may comprise a pure image, an action taken by the user (such as the selection of an internet link), an RFID tag, software inputs, and/or the like. The communicated data further may comprise at least one of a user ID, a hardware ID, a geocode, a timestamp, a subject code, a source code, and a content code.

The artifact of interest may comprise at least one of products, activities, services, print, visual, electronic or audible media, barcodes, brand names, product configurations, including, for example, packaging or container configurations, shapes or color combinations for products (e.g., pharmaceutical capsule color coding or pill shapes), video, body movements or gestures, olfactory scents, haptic or tactile stimuli, sound stimuli, and gustatory or taste stimuli.

A method for augmenting reality of a user having a sensory impairment, comprising the steps of: providing a computing device and a data capture system adapted for accepting input from and providing output to the user having sensory impairment in a form accessible to the user; capturing data corresponding to an artifact of interest to the user, in a form corresponding to the user's impaired sense; processing the captured data and formulating a first communication containing at least some of the captured data and communicating the first communication to a data repository; and receiving a response to the first communication from the data repository, the response containing at least some data corresponding to or relevant to the artifact of interest to the user and in a form useable or actionable to the user.

The captured data may be representative of at least one sensory input of visual, auditory, haptics, olfactory or gustatory. The visual sensory input may comprise at least one of visual pattern recognition, environmental or contextual recognition, text recognition, color recognition, motion detection, motion capture, motion recognition, or hand or body gestures. The auditory sensory input may comprise at least one of music, sound patterns, or natural or artificially-generated sounds. The olfactory sensory input may comprise at least one of data representing scents from foods, perfumes or colognes, environmental pollutants, ambient atmospheric scents, or gases emitted in agricultural or industrial production. The tactile sensory input may comprise at least one of data representing textiles; or material surface characterization, such as that during planarizing or patterning processes. The gustatory sensory input may comprise at least one of data pertaining to relative sweetness, tartness, bitterness, spiciness, acidity, basicity or other qualities pertaining to the taste of food-stuffs.

A system for shopping, comprising: a computing device; a data capture device capable of capturing at least one of visual, auditory, haptic, olfactory or gustatory sensory data; a communication circuit capable of communicating the captured sensory data; a data repository containing data corresponding to product and/or service descriptors; and a display screen capable of displaying graphical information corresponding to the captured sensory data and data received from the data repository.

What is claimed is:

1. A method for shopping using a computing device and a data capture system, comprising the steps of:
a. targeting with the data capture system a target of interest to a shopper;
b. capturing data from the target of interest, the data being representative of at least one sensory input of visual, auditory, haptics, olfactory or gustatory;
c. communicating at least some of the captured data to a data repository;
d. comparing the communicated data with information stored in the data repository; and
e. returning at least one response from the data repository to the computing device based upon the communicated data.

2. The method of claim 1, wherein the response further comprises information that prompts the shopper to take an action, prompts the shopper for a disposition on information provided, or provides information to the shopper relevant to either the target of interest or alternatives to the target of interest.

3. The method of claim 2, further comprising the step of communicating at least one shopper disposition on the prompt to the data repository.

4. The method of claim 3, further comprising the step of taking at least one action at the data repository based on the at least one shopper disposition on the prompt.

5. The method of claim 1, wherein the target of interest is an advertisement, the captured data is representative of the advertiser's brand, and the response comprises information such as other products of the advertiser that the shopper may be interested in, information about the particular product advertised, information about alternative products or services from competitive sources other than the advertiser, or information presenting the shopper with the advertiser's full internet affiliate site.

6. The method of claim 1, wherein the response comprises information representative of at least one of: links to brand names; products by brand name; product images; URLs for branded products; point of purchase URLs; customer reviews of branded products; pricing; product descriptions; links to product classifications; product configurations; brand names; styles; color combinations; customer reviews of products; links to music sources; classifications based upon artist; music genre; production label; music titles; album titles; customer reviews of music; music descriptions; artist descriptions; links to sources of scents; classifications based upon scent characterization; perfume product listings; product images; product information and pricing; links to sources of texture characterization; classifications of product types based upon texture characterization; links to sources of food taste characterization; classifications of food types; links to food sources; food descriptions.

7. The method of claim 1, further comprising the step of enhancing the at least one response based on ambient conditions determined either by the computing device or the data repository.

8. The method of claim 1, wherein the target of interest is an artifact capable of capture, comprising at least one of a barcode, a 2D code, a matrix code, a data matrix, a QR code, or other such symbology.

9. The method of claim 1, wherein visual sensory input comprises at least one of visual pattern recognition, environmental or contextual recognition, text recognition, color recognition, motion detection, motion capture, motion recognition, or hand or body gestures.

10. The method of claim 1, wherein auditory sensory input comprises at least one of music, sound patterns, or natural or artificially-generated sounds.

11. The method of claim 1, wherein olfactory sensory input comprises at least one of data representing scents from foods, perfumes or colognes, environmental pollutants, ambient atmospheric scents, or gases emitted in agricultural or industrial production.

12. The method of claim 1, wherein tactile sensory input comprises at least one of data representing textiles or material surface characterization, such as that during planarizing or patterning processes.

13. The method of claim 1, wherein gustatory sensory input comprises at least one of data pertaining to relative sweetness, tartness, bitterness, spiciness, acidity, basicity or other qualities pertaining to the taste of food-stuffs.

14. The method of claim 1, wherein the captured data is representative of at least one of voice, music, brand images, brand texts, product images, textile patterns, hand or body gestures, or environmental patterns such as building, signage or intersection landmarks.

15. The method of claim 1, wherein the response returned to the shopper is at least one of multi-modal and multi-variant.

16. The method of claim 1, wherein the target of interest comprises a pure image, an action taken by the shopper (such as the selection of an internet link), an RFID tag, software inputs, and/or the like.

17. The method of claim 1, wherein the captured data is communicated to the data repository by SMS protocol, MMS protocol, instant messaging, web browser based messaging, email, Enhanced Messaging System, TCP/IP, WAP, and/or the like.

18. The method of claim 1, wherein the target of interest comprises at least one of products, activities, services, print, visual, electronic or audible media, barcodes, brand names, product configurations including packaging or container configurations, shapes or color combinations for products, video, body movements or gestures, olfactory scents, haptic or tactile stimuli, sound stimuli, and gustatory or taste stimuli.

19. A method of structuring and interfacing with a database wherein data captured by a digital device is transmitted as a structured query to the database which returns a response to the digital device, comprising the steps of:
a. Capturing data corresponding to an artifact of interest to a user, wherein the digital device formulates a first communication with the data repository;
b. Processing the captured data and the first communication containing at least some of the captured data with a data repository; and
c. Receiving a response from the data repository, the response containing at least some data corresponding to or relevant to the artifact of interest to the user.

20. A method for augmenting reality of a user having a sensory impairment, comprising the steps of:
a. providing a computing device and a data capture system adapted for accepting input from and providing output to the user having sensory impairment in a form accessible to the user;
b. capturing data corresponding to an artifact of interest to the user, in a form corresponding to the user's impaired sense;
c. processing the captured data and formulating a first communication containing at least some of the captured data and communicating the first communication to a data repository; and
d. receiving a response to the first communication from the data repository, the response containing at least some data corresponding to or relevant to the artifact of interest to the user and in a form useable or actionable to the user.
